(19) United States
(12) Patent Application Publication
(10) Pub. No.: US 2023/0300795 A1
(43) Pub. Date: Sep. 21, 2023

(54) APPARATUSES AND METHODS FOR DOWNLINK NOTIFICATION MONITORING

(71) Applicant: HUAWEI TECHNOLOGIES CO., LTD., SHENZHEN (CN)

(72) Inventors: LIQING ZHANG, Kanata (CA); YONGXIA LYU, Shenzhen (CN); JUN WANG, Shenzhen (CN); TING WANG, Shenzhen (CN)

(21) Appl. No.: 18/323,052

(22) Filed: May 24, 2023

Related U.S. Application Data
(63) Continuation of application No. PCT/CN2021/074497, filed on Jan. 29, 2021.

(51) Int. Cl. H04W 68/02; H04W 52/02

(52) U.S. Cl. CPC H04W 68/02; H04W 52/0235

(57) ABSTRACT

During operation of some wireless communication systems, a user equipment (UE) may monitor a control channel for a downlink notification. An example of a downlink notification is a paging notification. It is desirable to reduce the amount of power consumed when monitoring for downlink notifications. In some embodiments, power savings may possibly be provided by reducing the frequency resources (e.g. bandwidth) over which monitoring for downlink notifications is to occur. In some embodiments, there may be an association between: (i) UE type, capability, and/or service, and (ii) which configuration of resources is used for the monitoring of downlink notifications. In some embodiments, there may be different possible configurations of frequency resources to be used during an initial access procedure, with each configuration possibly having a different bandwidth of frequency resources allocated for the initial access procedure.

### CROSS-REFERENCE TO RELATED APPLICATION

The present application is a continuation of PCT International Application PCT/CN2021/074497, titled “Apparatuses and Methods for Downlink Notification Monitoring”, filed on Jan. 29, 2021, and incorporated herein by reference.

### FIELD

The present application relates to wireless communication, and more specifically to monitoring for downlink notifications (e.g. paging notifications) in a wireless communication system.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a TRP may wirelessly transmit information to a UE in a downlink communication over a particular frequency (or range of frequencies) for a particular duration of time. The frequency and time duration are examples of resources, typically referred to as time-frequency resources.

In some operating states, e.g. in an Inactive or Idle state, a UE may monitor a downlink control channel for paging notifications from a TRP. A paging notification may be sent when there is downlink data to send from the network to the UE. However, monitoring for downlink notifications (e.g. paging notifications) consumes power, which is typically undesirable, especially when the UE is operating in a power saving state (e.g. in an Inactive or Idle state).

### SUMMARY

It is desirable to reduce the amount of power consumed when monitoring for downlink notifications. An example of a downlink notification is a paging notification. A downlink notification may be carried in a control channel, e.g. in a physical downlink control channel (PDCCH). As one example, a downlink notification may be a downlink control information (DCI) that schedules a message in a data channel, such as in a physical downlink shared channel (PDSCH). The scheduled message may be a notification message, such as a paging message. However, the downlink notification does not necessarily need to schedule a message in a data channel. The downlink notification itself may carry a notification message for the UE, e.g. a short message, which may be in a DCI. A downlink notification may be meant for a group of UEs (e.g. broadcast) or might be UE-specific. A UE may monitor for downlink notifications at particular time-frequency resources in a control channel. It is desirable to reduce the amount of power consumed by the UE to monitor for the downlink notifications.

In some embodiments, power savings may possibly be provided as follows: the frequency resources (e.g. bandwidth) over which monitoring for downlink notifications occurs is reduced compared to previous schemes. For example, instead of a UE monitoring for downlink notifications over 24 resource blocks (RBs) of a control channel, the UE may instead monitor for downlink notifications over 6 RBs. The term “bandwidth”, as used herein, may be expressed in hertz, or it may be expressed in another equivalent unit having a mapping to hertz (that may be a function of subcarrier spacing), such as RBs or resource elements (REs).

By reducing the frequency resources over which the monitoring occurs, the following technical benefit may be achieved in some embodiments: the realization of power savings due to having to monitor (e.g. perform blind detection on) fewer frequency resources. For example, reducing the monitoring bandwidth from 100 MHz to 20 MHz may possibly result in 50% power savings in downlink notification monitoring for a UE. Power savings may possibly be realized at the network side also because fewer frequency resources are being used to transmit the downlink notifications.

Reducing the frequency resources over which the monitoring occurs may result in a reduction in the number of bits of physical layer control signaling (e.g. DCI) that can be carried in the downlink notification. Therefore, in some embodiments, a DCI format is disclosed that is specific to paging and that has fewer bits compared to a previous DCI format.

In some embodiments, there may be different possible configurations of resources in a control channel over which downlink notifications may be transmitted and over which a UE may monitor for such downlink notifications. In some embodiments, each such configuration has a different bandwidth of frequency resources allocated for transmitting the downlink notifications/performing the monitoring. For example, a first configuration may configure 24 RBs in a control channel for monitoring of (and transmission of) downlink notifications, a second configuration may configure 12 RBs in a control channel for monitoring of (and transmission of) downlink notifications, and a third configuration may configure 6 RBs in a control channel for monitoring of (and transmission of) downlink notifications.

In some embodiments, there may be an association between: (i) UE type, capability, and/or service, and (ii) which configuration of resources is used for the monitoring. For example, a UE for which power savings is important (e.g. an internet-of-things (IOT) device operating on battery power) may be configured for downlink notification monitoring over 6 RBs, and a UE for which power savings is not as important (e.g. a device having power supplied from an electrical outlet) may be configured for downlink notification monitoring over 24 RBs. By having different configurations of frequency resources for monitoring for downlink notifications, the following technical benefit may be achieved in some embodiments: the flexibility to have different configurations for devices of different types, capabilities, and/or services.

In some embodiments, a UE operating in an Active/Connected state may receive, from the network, a configuration of frequency resources to be used for downlink monitoring when that UE transitions to (i.e. enters) a power saving state. A power saving state is sometimes alternatively referred to as a lower power state. An example of a power saving state is an Inactive or Idle state, such as the radio resource control (RRC) Inactive and RRC Idle states in an RRC protocol. The UE may receive the configuration before receiving an indication to transition to the power saving state, or the configuration may be received during or as part of the message exchange/protocol for transitioning to the power saving state. The following technical benefit may be achieved in some embodiments: different UEs may possibly be configured differently depending upon the type, capability, and/or service of the UE. For example, a UE for which power savings is important may be configured for downlink monitoring over 6 RBs in the power saving state, and a UE for which power savings is not as important may be configured for downlink monitoring over 24 RBs in the power saving state.

In some embodiments, there may be different possible configurations of frequency resources for monitoring for downlink notifications, as discussed above, and a UE may obtain the configuration during an initial access procedure.

Additionally or alternatively, in some embodiments, there may be different possible configurations of frequency resources to be used during an initial access procedure, with each configuration possibly having a different bandwidth of frequency resources allocated for the initial access procedure. As one example, two different synchronization signal block (SSB) formats may be transmitted by one or more TRPs: a first SSB format in which the SSBs have a bandwidth of 20 RBs, and a second SSB format in which the SSBs have a bandwidth of 6 RBs. As another example, there may be different possible configurations of frequency resources used, during initial access, for the network to transmit control information, and for a UE to monitor for such control information. The control information may schedule system information, e.g. the control information may schedule a system information block (SIB) 1. For example, there may be two different configurations: a first configuration in which the control information is transmitted over 24 RBs and hence the monitoring occurs over 24 RBs, and a second configuration in which the control information is transmitted over 6 RBs and hence the monitoring occurs over 6 RBs. There may be an association between the different configurations and UE types and/or UE capabilities. The following technical benefit may be achieved in some embodiments: the provision of a lower power option for initial access. For example, a UE for which power savings is important may perform initial access using an SSB and/or control channel monitoring of 6 RBs, which possibly allows for that UE to consume less power during the initial access procedure. Another UE for which power savings is not as important may perform initial access using a legacy SSB of 20 RBs and associated control channel monitoring of 24 RBs.

In some embodiments, a method performed by an apparatus (e.g. a UE) may include receiving a message indicating that the apparatus is to transition to a first operating state of at least one operating state. For example, the first operating state may be a power saving state. The method may further include receiving an indication of at least one frequency resource for a control channel, where the at least one frequency resource is associated with the first operating state. The method may further include monitoring for a downlink notification, in the first operating state, on the control channel at the at least one frequency resource. In some embodiments, different apparatuses may receive different configurations of frequency resources for monitoring for downlink notifications in the first operating state. In some embodiments, the configured frequency resource may be associated with apparatus type, apparatus capability, service type, and/or time of 24-hour day. In some embodiments, a method performed by a device (e.g. a network device, such as a TRP) may include transmitting a message indicating that the apparatus is to transition to the first operating state. The method may further include transmitting an indication of at least one frequency resource for a control channel, where the at least one frequency resource is associated with the first operating state. The method may further include communicating with the apparatus in the first operating state by at least transmitting a downlink notification on the control channel at the at least one frequency resource.

In some embodiments, a method performed by an apparatus (e.g. a UE) may include: during an initial access procedure, obtaining a first configuration of a plurality of configurations. The first configuration may indicate at least one frequency resource for at least one control channel. In some embodiments, the first configuration may be based on at least one of: the apparatus capability, apparatus type, or service type. In some embodiments, the method may further include monitoring the at least one control channel at the at least one frequency resource for a downlink notification. In some embodiments, the at least one frequency resource has a bandwidth that is different from a bandwidth of at least one other frequency resource for downlink notifications that is associated with a second configuration of the plurality of configurations. In some embodiments, a method performed by a device (e.g. a network device such as a TRP) may include: during an initial access procedure, transmitting to an apparatus (e.g. a UE), a message including a first configuration of a plurality of configurations. The first configuration may indicate at least one frequency resource for at least one control channel. The first configuration may be based on at least one of: the apparatus capability, the apparatus type, or service type. In some embodiments, the method further includes communicating with the apparatus after the initial access procedure, including transmitting a downlink notification on the at least one control channel at the least one frequency resource.

Corresponding apparatuses and devices are disclosed for performing the methods.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates three user equipments (UEs) communicating with a network device, according to one embodiment;

FIG. 6 illustrates a variation of FIG. 5 in which the UEs have different types and/or capabilities, according to one embodiment;

FIG. 7 illustrates power consumption for a UE when operating in a power saving state, according to one embodiment;

FIG. 8 illustrates an example of a synchronization signal block (SSB) and related control and data channel transmitted by a TRP, according to one embodiment;

FIG. 9 illustrates an example of paging notification monitoring, according to one embodiment;

FIG. 10 illustrates an example DCI 1_0 format;

FIG. 11 illustrates two UEs each having a different physical downlink control channel (PDCCH) resource configuration, according to one embodiment;

FIGS. 12 and 13 illustrate different SSBs and related control and data channels, according to various embodiments; and

FIGS. 14 and 15 illustrate methods performed by an apparatus and a device, according to various embodiments.

### DETAILED DESCRIPTION

For illustrative purposes, specific example embodiments will now be explained in greater detail below in conjunction with the figures.

### Example Communication Systems and Devices

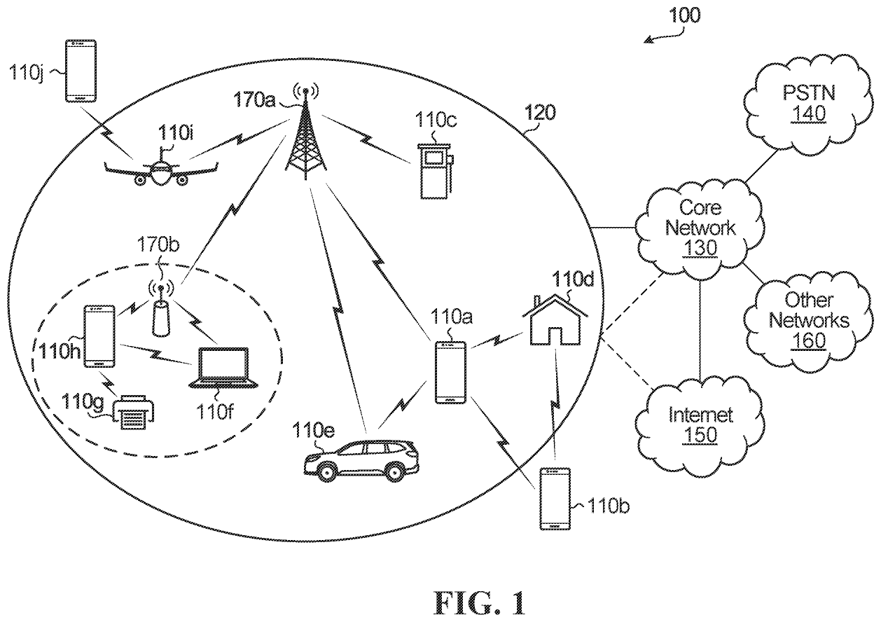

Referring to FIG. 1, as an illustrative example without limitation, a simplified schematic illustration of a communication system 100 is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

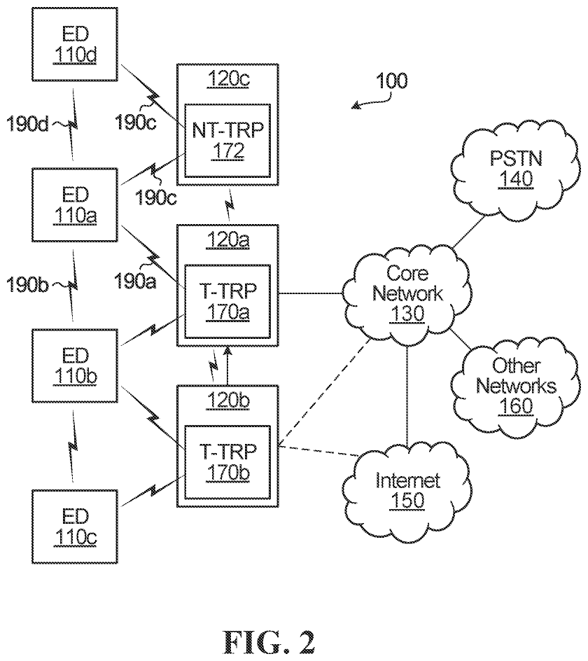

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

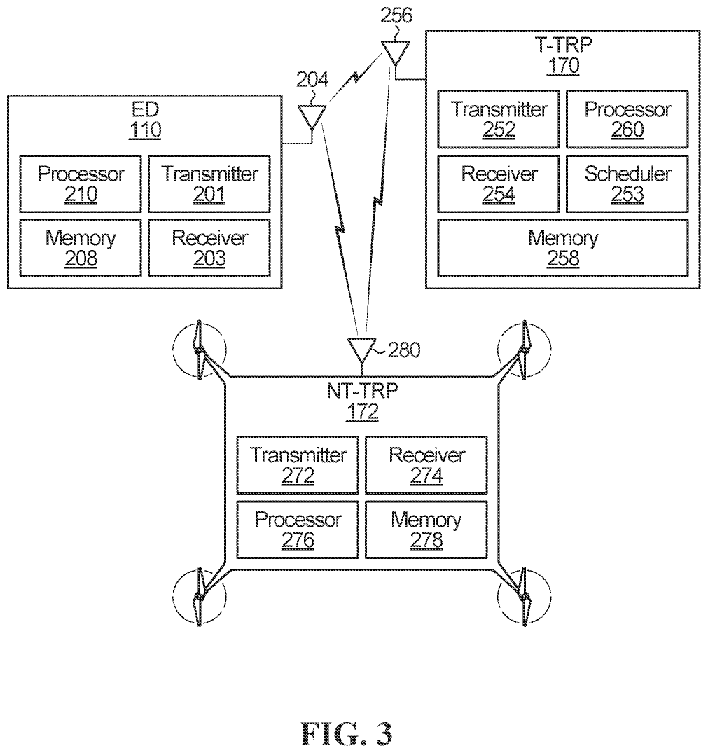

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

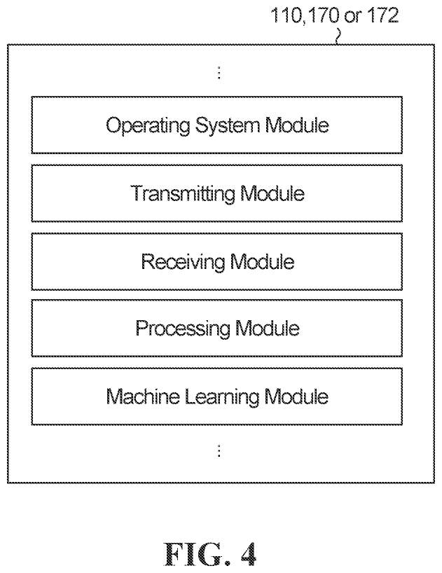

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein in some embodiments. Control information may sometimes instead be referred to as control signaling, or signaling. In some cases, control information may be dynamically indicated, e.g. in the physical layer in a control channel. An example of control information that is dynamically indicated is information sent in physical layer control signaling, e.g. downlink control information (DCI). Control information may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

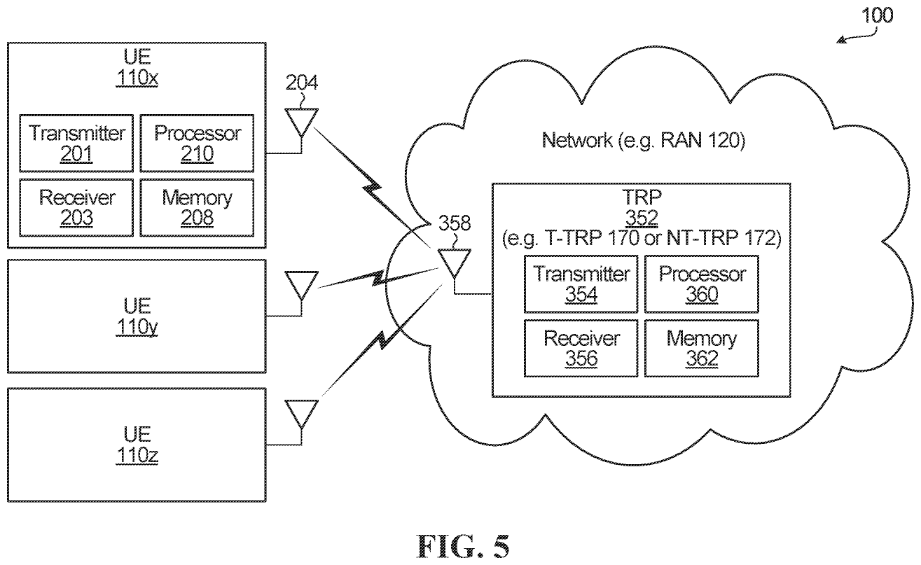

FIG. 5 illustrates three EDs communicating with a TRP 352 in the communication system 100, according to one embodiment. The three EDs are each illustrated as a respective different UE, and will be referred to as UEs 110x, 110y, and 110z. However, the EDs do not necessarily need to be UEs. In the following, the reference character 110 will be used when referring to any one of the UEs 110x, 110y, 110z, or any other UE (e.g. the UEs 110a-j introduced earlier).

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). Therefore, in some embodiments, the term TRP 352 may also refer to modules on the network side that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that: generate downlink notifications, schedule downlink notifications on configured resources in a control channel, generate the configurations of time-frequency resources (e.g. “PDCCH resource configurations”) discussed herein, generate the message instructing a UE to transition to a particular operating state (e.g. a power saving state), generate the downlink transmissions for initial access (e.g. SSBs), generate scheduled downlink transmissions, process uplink transmissions, etc. The modules may also be coupled to other TRPs. In some embodiments, the TRP 352 may actually be a plurality of TRPs that are operating together to serve UEs 110, e.g. through coordinated multipoint transmissions.

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) much of the operations described herein as being performed by the TRP 352, e.g. generating the downlink notifications, scheduling the downlink notifications on configured resources in a control channel, generating the configurations of time-frequency resources (e.g. “PDCCH resource configurations”) discussed herein, generating the message instructing a UE to transition to another operating state (e.g. a power saving state), generating the downlink transmissions for initial access (e.g. SSBs), generating scheduled downlink transmissions, processing uplink transmissions, etc. Generation of messages (e.g. downlink notifications) for downlink transmission may include arranging the information in a message format, encoding the message, modulating, performing beamforming (as necessary), etc. Processing uplink transmissions may include performing beamforming (as necessary), demodulating and decoding the received messages, etc. Although not illustrated, the processor 360 may form part of the transmitter 354 and/or receiver 356. The TRP 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

Each UE 110 (e.g. each of UEs 110x, 110y, and 110z) includes a respective processor 210, memory 208, transmitter 201, receiver 203, and one or more antennas 204 (or alternatively panels), as described earlier. Only the processor 210, memory 208, transmitter 201, receiver 203, and antenna 204 for UE 110x is illustrated for simplicity, but the other UEs 110y and 110z also include the same respective components.

The processor 210 performs (or control the UE 110 to perform) much of the operations described herein as being performed by the UE 110, e.g. transitioning the UE 110 to a particular operating state based on a received message, instructing the UE 110 to operate in the operating state, monitoring for downlink notifications, e.g. by performing the blind decoding described herein, obtaining and implementing the configuration of control channel resources for downlink monitoring, processing received downlink notifications, e.g. demodulating and decoding the DCI, implementing the initial access, e.g. performing the synchronization and obtaining the system information, etc. The processor 210 generates messages for uplink transmission and processes received downlink transmissions. Generation of messages for uplink transmission may include arranging the information in a message format, encoding the message, modulating, performing beamforming (as necessary), etc. Processing received downlink transmissions may include performing beamforming (as necessary), demodulating and decoding the received messages, etc. Although not illustrated, the processor 210 may form part of the transmitter 201 and/or receiver 203.

Different UEs may be of different types. A non-exhaustive list of examples of types include: IOT device, cellular phone, customer premises equipment (CPE), etc. In some embodiments, UE types may be predefined and each associated with a respective identifier (ID). The ID may also sometimes be called a flag. For example, an IOT device may have ID 0001, a cellular phone may have ID 0010, etc. The UE type may be reported, by the UE to the network, either implicitly or explicitly, e.g. during an initial access procedure, such as in a capability report.

Different UEs may have different capabilities. A non-exhaustive list of examples of capabilities includes: number of transmit antennas, number of receive antennas, frequency band(s) of operation, whether the UE supports scheduling free (“grant-free”) transmissions, etc. In some embodiments, there may be predefined capability categories, each associated with a different ID (which may sometimes instead be called a flag). For example, the ID 011010 may indicate that the UE has eight transmit antennas, two receive antennas, 100 MHz communication bandwidth, and the UE supports scheduling free transmissions, whereas the ID 011000 may indicate that the UE has one transmit antenna, one receive antenna, 20 MHz communication bandwidth, and UE does not support scheduling free transmissions, etc. The capability of the UE may be reported, by the UE to the network, either implicitly or explicitly, e.g. during an initial access procedure, such as in a capability report.

In some embodiments, each UE type is associated with particular capabilities, such that indicating the UE type also inherently indicates UE capability. The vice versa may instead be true in some embodiments, i.e. indicating UE capabilities may also inherently indicate UE type. In some embodiments, there is no concept of UE type, just UE capabilities. In other embodiments, there is no concept of UE capabilities per se, just UE type. In other embodiments, there is a concept of both UE type and UE capabilities, e.g. UEs of a same type may have different capabilities.

Different UEs may have/implement different types of services. A type of service may also be called a service type. A non-exhaustive list of examples of types of services includes: high reliability, low latency, delay tolerant, high throughput, low throughput, etc. Some service types may be associated with particular names, e.g. “enhanced mobile broadband (eMBB)”, “ultra-reliable low latency communication (URLLC)”, etc. In some embodiments, different types of service may be predefined and each associated with a respective identifier (ID). The ID may also sometimes be called a flag. For example, an eMBB service may have ID 110, a URLLC service may have ID 111, etc. The service type may be reported, by the UE to the network, either implicitly or explicitly, e.g. during an initial access procedure, such as in a capability report.

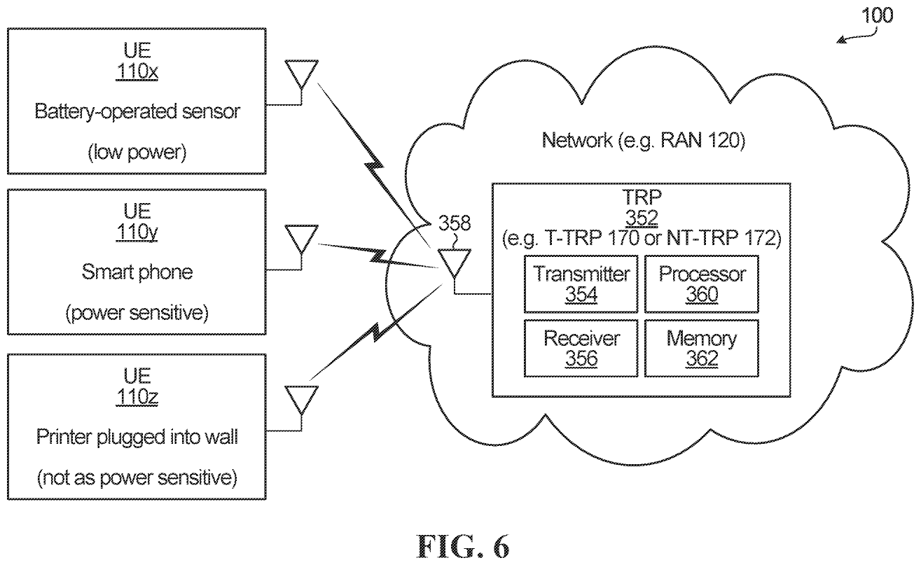

The UE type and/or capabilities and/or type of service implemented by the UE may be such that the UE is (or is assumed to be) sensitive to power consumption. For example, FIG. 6 illustrates a variation of FIG. 5 in which UE 110x is a battery-operated sensor, e.g. on a utility meter. It is important for UE 110x to consume low power so that it has a long life. UE 110y is a smart phone. UE 110y is power sensitive (also referred to as energy sensitive), but it can have its battery recharged and the user of the smart phone may have periods of time during which performance is valued over power consumption. UE 110z is a CPE in the form of a printer that only operates when plugged into an electrical outlet. Although power savings are beneficial, UE 110z is not as power sensitive.

As explained below, in some embodiments, each UE of a certain type and/or capability and/or service type may be associated with a control channel such as a PDCCH or data channel with a respective set of frequency resources over which that UE is to monitor for downlink notifications. The bandwidth of the frequency resources in the control channel or the data channel over which one UE is configured to monitor for downlink notifications may be different from the bandwidth of frequency resources in a control channel or data channel over which another UE is configured to monitor for downlink notifications. For example, UE 110x may be configured to monitor for a downlink notification on a PDCCH or PDSCH over 1 RB or 6 RBs, and UE 110z may be configured to monitor for a downlink notification on a PDCCH or PDSCH over 24 RBs. In some embodiments, the configured frequency resources on a control or data channel may change depending upon the time of 24-hour day, e.g. UE 110y may be configured to monitor for a downlink notification on a PDCCH or PDSCH over 24 RBs during daylight hours and otherwise is configured to monitor for a downlink notification over 6 RBs. Moreover or alternatively, a data channel may not need to be configured dynamically, and instead can be configured semi-statically, and thus the data transmission in the data channel can be performed like a grant-free transmission without dynamic grant in a transmission occasion.

### Different Operating States

In some embodiments, a UE 110 may operate in different states, e.g. a power saving state, a connected state, etc. When operating in certain states, e.g. when operating in a power saving state, the UE 110 might not fully occupy the system resources available for downlink and/or uplink transmission, e.g. the UE might not utilize all transmission parameters and time-frequency resources available for downlink and/or uplink transmission. For example, the UE 110 might not constantly (or as often) monitor for network instructions on the downlink, e.g. the UE 110 might not monitor a control channel, such as the PDCCH, as often. For example, if the UE 110 is a reduced capacity (RedCap) commercial device, a wearable devices, a low cost industry wireless devices, an IoT device, etc., then the UE 110 may operate in a power saving state much or all of the time.

In some embodiments, when not operating in the power saving state, e.g. when the UE 110 operates in a normal, enhanced, or higher power-consumption state, the UE 110 may fully occupy the system resources (e.g. the transmission parameters and/or time-frequency resources) that are available for uplink and/or downlink transmission, and/or the UE may constantly (or more often) monitor for network instructions on the downlink. For example, the UE may monitor the PDCCH regularly or more often than when in the power saving state.

In some wireless communication systems, the UE 110 and network operate according to a radio resource control (RRC) protocol. The RRC protocol has different states in terms of the UE operating behaviour and radio resource usage. For example, the RRC protocol may include: an RRC Idle state in which there is no RRC connection established with the network and no actual RRC configured resources are used; an RRC Connected state (also referred to as “Active state”) in which an RRC connection is established and full RRC configured radio resources are used by the UE; and an RRC Inactive state in which partial RRC resources are reserved and the RRC functions of the UE may be reduced, e.g. to help save power. In some embodiments, the Idle and Inactive states may be considered power saving states.

In some embodiments, within a single state (e.g. within a power saving state) there may be different operation modes that consume different amounts of UE power, e.g. a default operation mode and an enhanced operation mode. Each operation mode may correspond to a respective power (usage) mode. Example power modes might include sleep, wake-up, downlink reception only, both downlink reception and uplink transmission mode, etc. Multiple modes may be within a single state, and/or different states may have different modes. In some cases, transitioning from one mode to another mode might involve changing state. For example, the modes of “sleep” and “awake for downlink notification” might be two different power modes in a same power saving state, whereas the mode “both downlink reception and uplink transmission” may be a mode in a non-power-saving state (or normal transmit/receive power state).

In some embodiments, after or upon completing initial access to connect to the network, the UE 110 enters a default operation mode that is associated with lower power consumption and is within a power saving state. The UE 110 remains in the default operation mode by default, and may temporarily move into an enhanced operation mode on demand, e.g. upon arrival of uplink data to transmit to the base station 170. Moving into the enhanced operation mode might or might not cause the UE 110 to transition to a new or different state.

In some embodiments, when the UE 110 is in a power saving state, monitoring the downlink control channel, e.g. for DCI, might only be performed in a wake-up period of a discontinuous reception (DRX) cycle or DRX_on window.

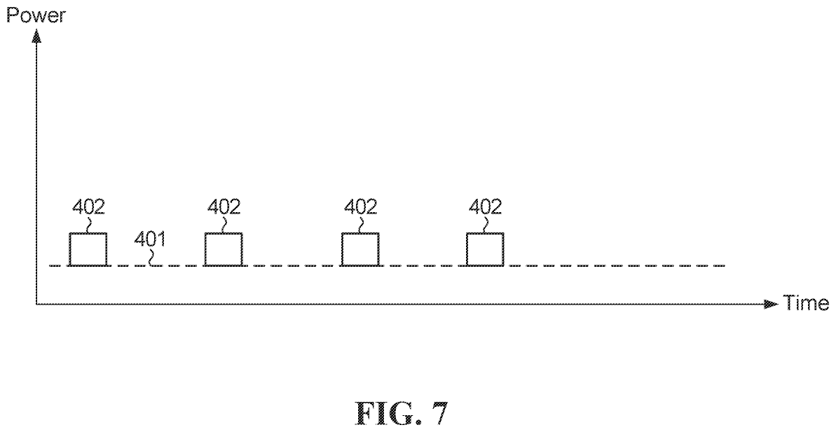

For the sake of example, FIG. 7 illustrates power consumption for the UE 110 when operating in a power saving state, according to one embodiment. Within the state, the UE 110 may operate in different power modes, e.g: a default sleep mode, which is a very low power mode when in a sleep duration; and a wake-up mode, which is a low power mode when in a wake-up duration (e.g. when in a wake-up period of a DRX cycle). Although not shown, there may be other modes within the power saving state, e.g. a temporary higher power mode for relatively short transmission or reception of data. The default sleep mode is indicated by dashed line 401. Periodic wake-up durations 402 are interspersed between the sleep durations, e.g. possibly at regular intervals, such as according to a DRX cycle. In a wake-up duration 402, the UE 110 consumes more power in order to perform operations such as monitoring for downlink notifications. Each wake-up duration 402 might possibly be a wake-up period of a DRX cycle or DRX_on window, depending upon the implementation.

### Initial Access and Paging Monitoring Configurations

In some embodiments, when a UE 110 is to initially connect with the network (e.g. upon powering on), the UE 110 performs an initial access procedure. The initial access procedure may include operations relating to synchronization, decoding and reading the system information, performing random access, etc., where the random access may be implemented in different ways, e.g. in terms of four-step RACH or two-step RACH, depending on the UE capability. For example, in one implementation: the UE 110 searches for one or more synchronization signals, e.g. a primary synchronization signal (PSS) and a secondary synchronization signal (SSS); the UE 110 decodes a physical broadcast channel (PBCH) to read a master information block (MIB) in order to obtain necessary system information; information in system information blocks (SIBs) are also read; and the UE 110 performs a random access procedure. The random access procedure is sometimes referred to as a random access channel (RACH) procedure and may include: transmission of a preamble (RACH preamble) (“msg1”) by UE 110; receipt of a random access response (RAR) (“msg2”) from base station 170; transmission of information, such as a RRC connection request (“msg3”) by UE 110; and a response to msg3 (“msg4”), e.g. connection confirmation information, from base station 170.

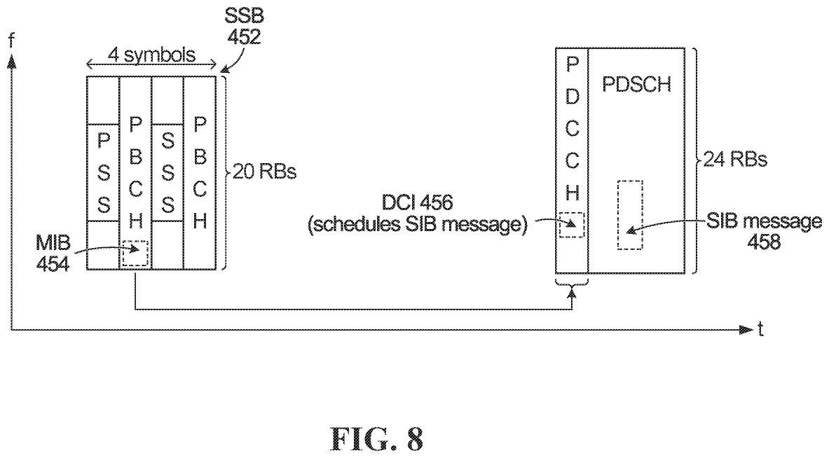

FIG. 8 illustrates an example of a SSB 452 and related PDCCH and PDSCH transmitted by TRP 352, according to one embodiment. The SSB block is four symbols in time and 20 RBs in frequency. As used herein, a RB is a group of REs occupying a predefined number of subcarriers (e.g. 12 subcarriers) in the frequency domain, where a RE is one frequency element or one subcarrier.. The RB may be a virtual RB or a physical RB.

The SSB carries a PSS, a SSS, and a PBCH. Although not shown, the SSB may also carry at least one reference signal and/or pilot. The PBCH carries a MIB 454 that indicates the time-frequency location of resources in a PDCCH at which control information is transmitted by the TRP to schedule a transmission of the system information message . The UE 110 monitors the PDCCH at the time-frequency resources indicated in the MIB 454 and obtains DCI 456. The DCI 456 schedules transmission of a SIB message 458 in PDSCH as shown in FIG. 8, where the PDCCH and PDSCH may take frequency resources of 24 RBs as an example, and more RBs for the PDCCH and PDSCH can be configured in the MIB 454. In some embodiments, the SIB message 458 is SIB 1.

In some embodiments, the SIB message 458 is used to configure serving cell initial access and control channel parameters, including the paging monitoring parameters and paging PDCCH configuration. The PDCCH resources for paging monitoring may be configured by configuring at least one control resource set (CORESET) and a set of PDCCH candidates within the at least one CORESET. A CORESET is a set of time-frequency resources and may be configured to have a certain number of RBs in the frequency domain (e.g. 24, 48, or 96 RBs) and a certain duration of time (e.g. up to 3 symbols). A PDCCH candidate is also referred to as a search spaces (SS), and refers to a set of time-frequency resources within a CORESET at which the UE is configured to monitor, e.g. for a paging notification, where one SS may be defined in terms of aggregation level (AL). A total of SSs or PDCCH candidates may depend on how many types of ALs and how many SSs per AL are configured. In some embodiments, an AL n may be defined where n is either 1, 2, 4, 8 or 16, and a SS with AL n occupies n control channel element (CCE) resources. A CCE may be predefined by the network and is a bundling of # of resource element groups (REGs), where a REG is predefined 1 RB (frequency domain) and 1 symbol resource. For example, a CCE may be 6 RBs in the frequency domain by 1 symbol in the time domain.

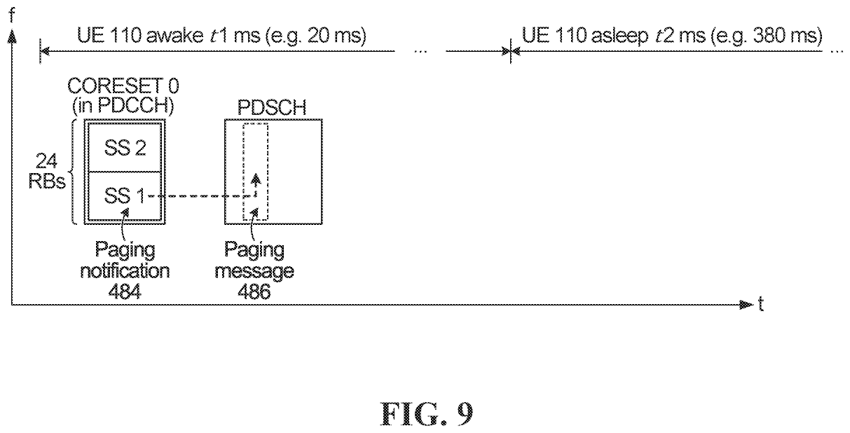

To assist with the explanation, one specific example of paging notification monitoring that may be configured by SIB message 458 (after initial access) is illustrated in relation to FIG. 9. The SIB message 458 indicates at least one CORESET, which in this example is CORSET #0. The SIB message 458 also indicates PDCCH candidates within the CORESET #0. Each PDCCH candidate is a respective search space (SS) in the CORESET #0 at which DCI scheduling a paging message may be located. The SSs (PDCCH candidates) may be configured by indicating one or more CCE ALs and a number of PDCCH candidates per AL. For example, such information may be carried in a “PDCCHConfigCommon” field in SIB 1 or configured by higher layer signaling “PDCCHConfigCommon”. In the example illustrated in FIG. 9, the SIB message has configured paging monitoring by indicating the following: a CORESET #0 of 24 RBs by 2 symbols, and two SSs each with aggregation level of 4 (where 1 CCE is 6 REGs). Because the AL=4, a PDCCH candidate (or one search space) therefore occupies 4×6 REGs=24 REGs. In the illustrated example there are two PDCCH candidates (search spaces) in the CORESET #0, which are called SS1 and SS2. Each search space occupies half the bandwidth (12 RBs) and 2 symbols of the CORESET #0. A DCI having a paging notification (i.e. scheduling a paging message) may possibly be sent in SS 1 or SS 2. Note that it is possible that no paging DCI is present in some instances. The example in FIG. 9 assumes that in this instance a paging notification 484 does happen to be present in SS 1.

In operation, the UE 110 is in a power saving state and periodically wakes up, e.g. according to a DRX cycle. In a wakeup duration, based on the configuration of PDCCH resources for paging monitoring discussed above, the UE 110 monitors and tries to detect SS 1 and SS 2 at the configured resources to figure out if any SS (i.e., SS1 or SS2) is present to carry a DCI signaling towards the UE (by unscrambling CRC with an ID, see below), and if the DCI is present, check if a paging notification 484 inside the DCI is a paging message itself and/or has scheduled a PDSCH to transmit a paging message In this case, the paging notification 484 has scheduled a paging message 486 in a PDSCH, as shown by stippled line 488.

A bandwidth-part (BWP) is a set of frequency subcarriers. The frequency subcarriers are assumed to contiguous, although this is not necessary (the frequency subcarriers could be non-contiguous). A BWP has a bandwidth. The BWP of the PDSCH may be the same as the BWP of the PDCCH, which is the case illustrated in FIG. 9. Alternatively, the BWP of the PDSCH may be the same as an initial downlink BWP, which might be different from the BWP of the PDCCH.

In general, the network might or might not have a paging notification for the UE 110, and if a paging notification is to be sent to the UE 110, the network can dynamically indicate it in one of the PDCCH candidates (e.g. in SS 1 or SS 2 in the illustrated example). Therefore, the UE 110 performs blind detection in the PDCCH candidates (search spaces) to determine if a paging notification is present. The blind detection may operate as follows: for each PDCCH candidate (e.g. for each of SS 1 and SS 2 in FIG. 9), the UE 110 attempts to decode the DCI carried by the PDCCH candidate, unscrambles the CRC of the DCI using a paging-specific ID (e.g. P-RNTI), and checks if the CRC is valid. If the CRC is not valid, the UE 110 assumes there is no paging notification in that PDCCH candidate. If the CRC is valid, the UE assumes the decoded DCI of the PDCCH candidate is correct and carries a paging notification. In the example in FIG. 9, SS 1 carries a paging notification 484. The paging notification 484 schedules a paging message 486 in the PDSCH.

Note that in some embodiments a PDCCH configuration (such as that shown in FIG. 9) may be changed for UEs in Active/Connected state after the initial access.

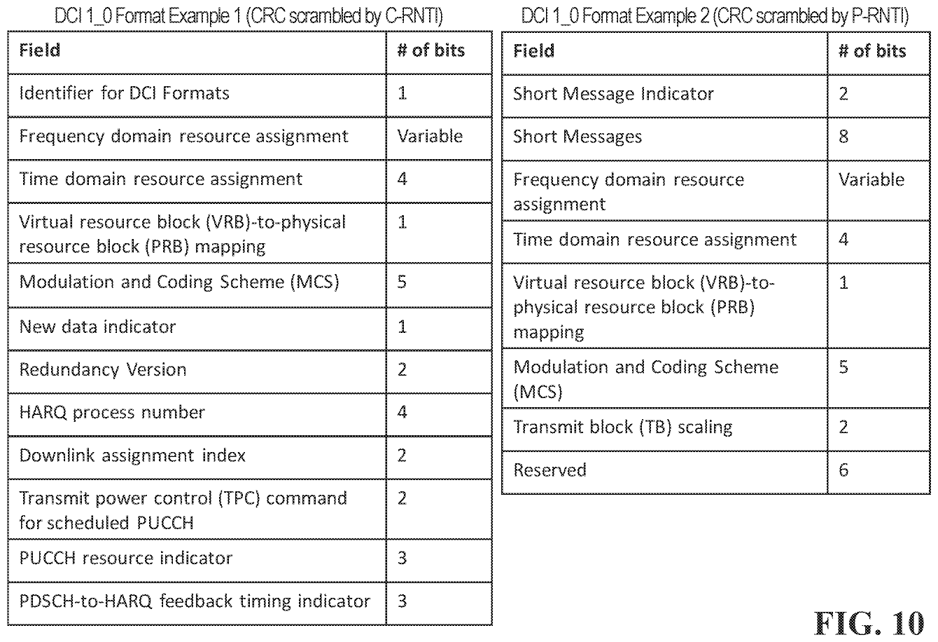

In some embodiments, one DCI format of same bit size may be used for transmitting different information, e.g. for scheduling different transmissions. There may be multiple scheduling types, but in one example a single DCI format may be able to carry a paging notification (that may schedule a paging message) or instead carry information scheduling a data transmission. An example is DCI 1_0 format. The contents of the DCI are different depending upon whether the DCI is carrying a paging notification or scheduling a data transmission, and a different ID is used to scramble the CRC of the DCI depending upon whether the DCI is carrying a paging notification or scheduling a data transmission. For example, the CRC may be scrambled by a paging radio network temporary identifier (P-RNTI) if the DCI is carrying a paging notification, and the CRC may instead be scrambled by a cell-RNTI (C-RNTI) if the DCI is scheduling a data transmission. Note that a P-RNTI identifier can be used by a group of UEs or can be used by only one UE, and a C-RNTI is usually UE-specific. This may allow for savings and/or more efficient DCI detection in the number of DCI formats used and/or sharing of resources in the control channel. FIG. 10 illustrates an example in which a single DCI 1_0 format may be used to carry a paging notification or schedule a data transmission. In Example 1 of FIG. 10, the DCI 1_0 format schedules a data transmission, and its CRC is scrambled by a C-RNTI. In Example 2 of FIG. 10, the DCI 1_0 format carries a paging message and its CRC is instead scrambled by a P-RNTI. In both examples, the DCI 1_0 format has the same number of bits, but different bit fields.

### Power Consumption When Monitoring for Notifications and Performing Initial Access

Monitoring for downlink notifications (e.g. paging notifications) on PDCCH (and/or PDSCH) consumes power. Moreover, the power consumption is a waste if the blind detection performed by the monitoring of PDCCH reveals that there is no downlink notification for the UE 110. For example, in FIG. 9 it could instead be the case that at the illustrated instance there is no paging notification 484 for UE 110. The UE 110 does not know and still has to perform the blind detection to determine whether or not a paging notification 484 is present.

Moreover, in future networks, there may be a wide variety of UEs, including UEs that may be low power/power sensitive and commonly deployed, and all of which have a common and key requirement of power saving and battery life. An example is UE 110x described earlier. For such UEs, it may be that during their operation one of the most power inefficient tasks they perform is to periodically wake up to monitor for possible downlink notifications. Moreover, due to fast data transmission capabilities in future networks, it may be the case that many UEs may operate in a power saving state, such as in an Inactive or Idle state (or the equivalent) during much of their operation. However, some previous networks are oriented more for devices for which throughput is important. Therefore, in some previous networks, the bandwidth of the paging monitoring is at least 24 RBs, like in the example illustrated in FIG. 9.

It is desirable to reduce the amount of power consumed for monitoring downlink notifications, particularly when the UE 110 is in a power saving state, such as an Inactive or Idle state. One possibility is to implement paging enhancements that have different wake-up signaling or different DRX configurations to try to reduce power consumption for downlink notification monitoring with longer wake-up periodicity. This is a time-domain related solution, and may incur a delay for paging message reception.

Some embodiments herein instead aim to reduce power consumption by reducing the frequency resources (e.g. number of RBs or REs) monitored by the UE 110 when monitoring for downlink notifications. Such embodiments may be applied on top of (e.g. in conjunction with) time-domain related solutions, or instead of time-domain related solutions. Reducing the bandwidth over which downlink monitoring occurs may result in notable power savings. The specific amount of power savings depends upon the implementation, but if the downlink monitoring bandwidth is reduced from 100 MHz to 20 MHz, there could possibly be a 50% savings in power. The bandwidth (as expressed in hertz) may be reduced by reducing the number of RBs over which the UE monitors. The bandwidth in hertz is a function of RBs and the subcarrier spacing (SCS) of the UE 110. In one example, for PDCCH monitoring over 100 MHz bandwidth, the power consumption may be 100 units (where a unit is based on the minimum operation power consumption), and PDCCH+PDSCH detection over 100 MHz may consume 300 units of power. However, using a 20 MHz bandwidth instead, PDCCH monitoring power consumption may be 50 units (50% power reduction), and PDCCH+PDSCH detection over 20 MHz may consume 120 units of power (60% power reduction).

Because some previous networks are oriented more for devices for which throughput is important, the frequency resources for initial access may be 20 RBs or larger, e.g. as shown in FIG. 8. Similarly, the PDCCH monitored during initial access may be 24 RBs or larger, e.g. as also shown in FIG. 8. Some embodiments herein aim to reduce power consumption by reducing the frequency resources (e.g. number of RBs or REs) used for performing initial access.

In some embodiments, different UEs may be configured to use different configurations of resources for downlink monitoring and/or initial access. UEs of different types and/or capabilities and/or service types may each be associated with a respective configuration that may be preconfigured or predefined. For example, power sensitive UEs may be configured to use frequency resources having a bandwidth that is smaller than the bandwidth of frequency resources used by other UEs that are not as power sensitive.

Embodiments are discussed below including those in which PDCCH resources to be used by a UE to monitor for downlink notifications is configured at different times, e.g. when the UE is to transition to a power saving state, and/or during initial access, etc. Embodiments are also discussed below relating to using fewer frequency resources to perform an initial access procedure. The different embodiments may be implemented separately or in combination with each other.

### Configuring Resources for Monitoring for Downlink Notifications

In some embodiments, the TRP 352 may provide, to UE 110, an indication of control channel resources for use by the UE 110 to monitor for downlink notifications. The control channel resources will be referred to as PDCCH resources, and indicating the PDCCH resources will be referred to as indicating a PDCCH resource configuration for downlink notifications. The indication of the PDCCH resource configuration may at least include or be an indication of frequency resources that are to be used by the UE 110 to monitor for downlink notifications.

In general, a downlink notification may be UE-specific or for a group of UEs. If a downlink notification is UE-specific, the downlink notification may be unicast to the UE 110, e.g. the DCI carrying the downlink notification may be scrambled using a UE-specific ID. If a downlink notification is for a group of UEs, the downlink notification may be group-cast or broadcast for reception by a plurality of UEs, including UE 110. For a downlink notification for a group of UEs, the DCI carrying the downlink notification may have its CRC scrambled by an ID known by the plurality of UEs, e.g. a paging-ID (P-RNTI) or a group ID. The same PDCCH resource configuration may be provided to the plurality of UEs for those UEs to monitor for a downlink notification. As discussed herein, UEs of different types, capabilities, services, etc. may be associated with different PDCCH resource configurations. For example, all power sensitive UEs may obtain a PDCCH resource configuration of a first (smaller) bandwidth for monitoring for downlink notifications, and all UEs not power sensitive may obtain a PDCCH resource configuration of a second (larger) bandwidth for monitoring for downlink notifications. In any case, a downlink notification may be carried in physical layer signaling, e.g. physical layer control signaling, such as in a DCI. The downlink notification may be (or be included in) a DCI that schedules a notification message (e.g. a paging message) in a data channel such as PDSCH, or the downlink notification may be a notification message (such as a paging message or short message) included in a DCI.

In some embodiments, the indication of a PDCCH resource configuration may include or be an indication of a CORESET and/or one or more search spaces (PDCCH candidates) within the CORESET that are associated with a BWP. The BWP defines a set of frequency resources that may be characterized by a bandwidth in hertz or another equivalent unit, e.g. RBs. In some embodiments, the BWP configuration may be cell specific or UE specific. In some embodiments, the PDSCH channel for transmission of a downlink message and the PDCCH carrying the downlink notification that schedules the PDSCH may be within a same BWP. The CORESET defines the time-frequency resources the search space(s) will be within. The CORESET may be configured within a BWP, in which case the CORESET has a bandwidth equal to or less than the bandwidth of the BWP. In some embodiments, the one or multiple search spaces (PDCCH candidates) in the CORESET may be defined by indicating aggregation levels (ALs) and number of candidates per AL.

In some embodiments, the indication of a PDCCH resource configuration may include or be an indication of at least one of BWP, CORESET, or search space, with the parameters not indicated being predefined, preconfigured, or fixed (e.g. in a standard). In some such embodiments, the BWP defines the frequency BW, e.g. 6 RBs. The CORESET is a set of time-frequency resources within the BWP and having frequency resources with a bandwidth equal to or less than the bandwidth of the BWP. Indicating the CORESET may include indicating a time-domain duration (e.g. 2 symbols) and time location (e.g. offset from a reference point). The search space is one or multiple search spaces (PDCCH candidates) in the CORESET. In some embodiments, the search space set may be defined by indicating ALs and number of candidates per AL.

UEs of different types, capabilities, and/or service types may obtain different configurations of PDCCH resources to be used to monitor for downlink notifications. For example, a UE that is more power sensitive may obtain a PDCCH resource configuration having fewer frequency resources, e.g. 6 RBs instead of 24 RBs.

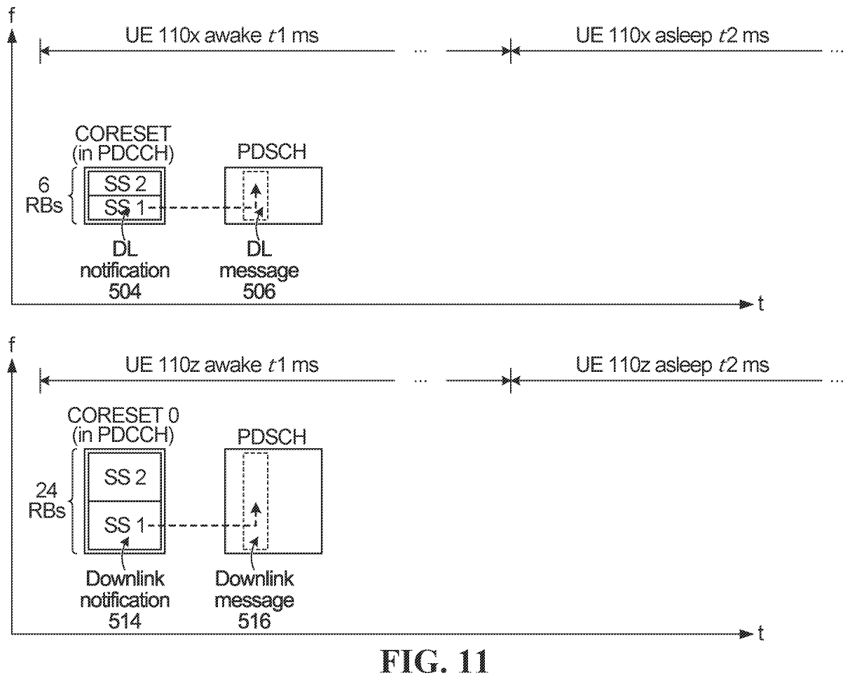

FIG. 11 illustrates two UEs each having a different PDCCH resource configuration, according to one embodiment. In FIG. 11, the UEs are in a power saving state in which they sleep, but periodically wake up to monitor whether a downlink notification is present on the configured PDCCH resources. The two UEs in FIG. 11 are UE 110x and UE 110z introduced earlier. UE 110x is power sensitive and has a PDCCH resource configuration for downlink monitoring with a bandwidth of 6 RBs. In the instance illustrated in FIG. 11, UE 110x performs downlink monitoring on the 6 RBs and, based on the illustrated example configuration, has two search spaces (PDCCH candidates) to blindly detect, each 3 RBs in the frequency domain. A downlink notification 504 happens to present that schedules a downlink message 506 in the PDSCH. UE 110z is not power sensitive and has a PDCCH resource configuration for downlink monitoring with a bandwidth of 24 RBs. In the instance illustrated in FIG. 11, UE 110z performs downlink monitoring on the 24 RBs and, based on the illustrated example configuration, has two search spaces (PDCCH candidates) to blindly detect, each 12 RBs in the frequency domain. A downlink notification 514 happens to present that schedules a downlink message 516 in the PDSCH.

Assuming monitoring occurs over a same duration of time (e.g. same number of symbols) for UE 110x and 110z, as illustrated in FIG. 11, then UE 110x requires less power to perform the downlink monitoring than UE 110z because UE 110x has fewer resources to blindly detect. However, the downlink notification 504 is fewer bits than downlink notification 514. The reduction in power means less throughput in terms of number of bits transmitted from the TRP 352 and received and decoded by the UE 110x for downlink notification 504 compared to downlink notification 514.

Therefore, a reduction in frequency resources allows for power savings but also affects throughput, assuming all other things being equal (e.g. a same time duration for monitoring, etc.). For example, downlink notification 504 carries fewer bits than downlink notification 514. In some embodiments, fewer bits available for a downlink notification may be accommodated in different ways. For example, a same DCI format may be used, but with a modulation and/or coding scheme adjusted (e.g. less redundancy) such that the same information can be provided in fewer bits when the PDCCH resource configuration has fewer frequency resources. As another example, a new DCI format may be provided that is fewer bits. For example, downlink notification 504 monitored by UE 110x may be a paging notification that is carried by a new DCI format that is a modification of DCI format 1_0 Example 2 illustrated in FIG. 10. For example, the reserved bits may be omitted and the MCS fixed, which would save 11 bits prior to coding. The 8 bits allocated to the “Short Messages” field may also or instead be reduced to save bits.

Although only two examples of PDCCH configurations are shown in FIG. 11, there may be more than two configurations. Also, the 24 RBs and 6 RBs bandwidths are only examples. Moreover, the specifically configured CORESETs and search spaces in FIG. 11 are also only an example. Also, FIG. 11 illustrates the downlink message in a PDSCH having a bandwidth that is the same as the bandwidth of the PDCCH used for monitoring for the downlink notification. This is not necessary, e.g. it could be that the PDSCH has a different bandwidth and/or is on a different BWP. Also, it need not necessarily be the case that the downlink notification 504 and/or 514 schedules a downlink message in a PDSCH. It could instead be that the downlink notification itself in the PDCCH carries a message for the UE, with no scheduling of a separate downlink message. That is, “downlink notification” as used herein, is broader than DCI scheduling a downlink message, but can also or instead encompass DCI providing a message itself (e.g. a short message or paging message itself), in which case there may be no separate downlink message scheduled in a data channel.

For the sake of example, the following are four different possible PDCCH resource configurations that may be implemented in some embodiments, where each PDCCH resource configuration is referred to as a “PDCCH parameter set”:
(1) PDCCH parameter set 1: CORESET of 24 RBs or more with time duration of 1, 2, or 3 symbols; PDCCH SS of AL1, AL2, AL 4, AL 8 or AL16; DCI format being a newly designed one or equal to new radio (NR) DCI format 1_0 or 1_1.
(2) PDCCH parameter set 2: CORESET of 12 RBs or more with time duration of 1, 2, or 3 symbols, but the CORESET time-frequency resources are fewer than the ones in PDCCH parameter set 1; PDCCH SS of AL1, AL2, AL 4, or AL8; DCI format having fewer bits than DCI format 1_0 or 1_1, and/or being a newly designed one.
(3) PDCCH parameter set 3: CORESET of 6 RBs or more with time duration of 1, 2, or 3 symbols, but the CORESET time-frequency resources are fewer than the ones in PDCCH parameter set 2; PDCCH SS of AL 1, AL 2, or AL4; DCI format having fewer bits than DCI format in PDCCH parameter set 2, and/or being a newly designed one.
(4) PDCCH parameter set 4: CORESET of 1 RB or more with time duration of 1, 2, or 3 symbols, but the CORESET time-frequency resources are fewer than the ones in PDCCH parameter set 3; PDCCH SS of AL1 or AL2; DCI format having fewer bits than DCI format in PDCCH parameter set 3, and/or being a newly designed one.

The provision of multiple possible PDCCH parameters sets, like in parameter sets (1) to (4) above as examples, may allow for the accommodation of different devices and/or future standards and/or backward compatibility.

In some embodiments, for a small CORSET size, e.g. for PDCCH parameter set (3) and/or (4), the AL may be pre-defined or configured to use fewer REs.

In some embodiments, the PDCCH resource configurations (e.g. the PDCCH parameter sets (1) to (4) above) may be pre-defined or configured in higher layer signaling (e.g. RRC signaling) or in a MAC CE. In some embodiments, different PDCCH resource configurations may be defined within different BWPs. In some such embodiments, the BWPs may be pre-defined or configured to satisfy the different power usage needs of diverse UE/devices (power capability) types.

In some embodiments, one UE (and/or a group of UEs) may be associated with one or more PDCCH resource configurations based on its (or their) type, capability and/or power consumption requirement. In one example, a power sensitive UE, such as UE 110x, may be associated with one or more PDCCCH resource configurations based on the UE power sensitive type and power consumption requirements. In some embodiments, a power sensitive UE in a power saving state (such as in an Inactive or Idle state) may keep an association with one PDCCH resource configuration (e.g. PDCCH parameter set (3)). The association between UE type (and/or other features) and PDCCH resource configuration may be predefined, RRC configured, and/or dynamically indicated such as using DCI. In other embodiments, a UE may be configured one or more PDCCH resources when the UE transitions to a different power mode in a configuration signaling; for example, when a UE transitions from one actively power usage mode to a power saving mode, the UE may be configured a PDCCH (e.g., during an RRC release message or network transition instruction message) with smaller number of RBs or REs for its periodic wake-up and downlink notification monitoring; this is especially important to a power sensitive UE where the power consumption is of main concern. In another embodiment, a UE may be configured PDCCHs with different resources for different power states or modes (including different power saving modes/states, actively power usage modes/states) based on, e.g., the association between the UE (or UE type/capability/service). For example, a power sensitive UE may be configured a PDCCH (e.g., during an RRC release message or network transition instruction message) with small or smaller number of RBs or REs for its periodic wake-up and downlink notification monitoring when the UE is in a power saving mode (or state). The configuration can be predefined, indicated in RRC signaling and/or dynamically indicated such as using DCI. The RAN 120 may need to record the association between the UE (or UE type/capability/service) and the PDCCH resource configuration.

By having different PDCCH resource configurations for downlink monitoring, different UEs 110 may obtain different PDCCH configurations, in a customized fashion depending upon the type, capability, service, and/or needs of the UE 110. Embodiments may be implemented in the context of both RAN-based paging and core network (CN)-based paging, e.g. when the downlink notification referred to is a paging notification.

In some embodiments, every UE 110 by default obtains a PDCCH configuration for downlink notification monitoring that has reduced frequency resources (e.g. only 6 RBs), on the assumption that power savings is useful for all UEs 110, regardless of the capabilities of and/or type and/or service needs of a UE. However, there may be a few possible exceptions. One example possible exception is as follows: legacy UEs unable to implement downlink notification monitoring on reduced frequency resources (e.g. because they are unable to properly read the reduced DCI) may be given a legacy PDCCH resource configuration, e.g. of 24 RBs in the frequency domain. Another example possible exception is as follows: a UE 110 that is not power sensitive (at least at a particular point in time) and for which throughput is important may request and/or be given a PDCCH resource configuration having more frequency resources, e.g. of 24 RBs in the frequency domain.

The PDCCH resource configuration for a UE 110 may be obtained in different ways and/or at different points in time, depending upon the scenario or implementation.

In some embodiments, a UE 110 operates in different RRC or power usage states, including a power saving sate (e.g. an Inactive or Idle state) and a non-power saving state (e.g. an Active/Connected state). Different operating states are discussed earlier. In some such embodiments, for the UE 110 to transition to (i.e. enter) a power saving state, the TRP 352 may send a message to the UE 110 indicating that the UE 110 is to transition to the power saving state. In some scenarios or implementations, the message is sent at the initiative of the network, e.g. if there is no downlink data to send to UE 110 and/or upon expiry of a timer. In other scenarios or implementations, the message may be sent in response to a request from the UE 110 to transition to the power saving state. When a UE 110 is in a power saving state, the UE 110 may be configured to wake up periodically (e.g. like shown in FIG. 7) and monitor for a downlink notification, such as a paging notification.

In some embodiments, the PDCCH resource configuration may be provided to the UE 110 during or as part of the message exchange/protocol for transitioning the UE 110 to the power saving state. For example, at the same time as the TRP 352 instructs the UE 110 to transition to the power saving state, the TRP 352 may provide the UE 110 with the PDCCH resource configuration for downlink notification monitoring when in that power saving state. As an example, the PDCCH resource configuration may be transmitted within or along with a “suspension message” when transitioning the UE 110 to an Inactive state, e.g. a SuspendConfig or other release message may include an information element (IE) to configure a customized PDCCH for downlink monitoring (e.g. paging) of a UE based on the UE type/capability/service/time-of-day, etc., where the IE may include one or more of at least BWP, CORESET, search space. As another example, the PDCCH resource configuration may be transmitted within or along with an “RRC release message” when transitioning the UE 110 to an Idle state, e.g. an RRC release message may include an IE to configure a customized PDCCH for downlink monitoring (e.g. paging) of a UE based on the UE type/capability/service/time-of-day, etc., where the IE may include one or more of at least BWP, CORESET, search space.

In other embodiments, the PDCCH resource configuration for downlink notification monitoring may be provided to the UE 110 at an earlier point in time (but after initial access), e.g. when the UE 110 is operating in the Active/Connected state. For example, when the UE 110 is operating in an RRC Active/Connected state, the TRP 352 may transmit a message to the UE 110 indicating the PDCCH resource configuration for downlink notification monitoring when in a power saving state. At a later point, the TRP 352 may subsequently transition the UE 110 out of the RRC Active/Connected state to a power saving state, such as into an RRC Idle or RRC Inactive state. When the UE 110 enters that power saving state, the UE 110 uses the PDCCH resource configuration for downlink notification monitoring that was previously configured when the UE 110 was in the RRC Active state.

In some embodiments, each UE 110 indicates its type and/or capabilities and/or needs (e.g. service) to the TRP 352, e.g. during initial access, such as in a capability report. There is an association between different UE types, capabilities, and/or services and different PDCCH resource configurations. Based on the type of UE 110, capability of the UE 110, and/or type of service implemented by the UE 110, the network provides a particular PDCCH resource configuration. For example, if a UE 110 identifies as an IOT battery operated device, the network provides a PDCCH resource configuration having 6 RBs of frequency resources for downlink notification (as is the case for UE 110x in FIG. 11), whereas if a UE 110 identifies as a smartphone or CPE, the network provides a PDCCH resource configuration having 24 RBs of frequency resources for downlink notification (as is the case for UE 110z in FIG. 11). In some embodiments, the time of 24-hour day may also or instead be used to determine the PDCCH resource configuration. For example, if the UE 110 enters the power saving state outside of business hours, the network provides a PDCCH resource configuration having 6 RBs of frequency resources for downlink notification on the assumption that throughput is not as important, whereas if the UE 110 enters the power saving state during business hours, the network provides a PDCCH resource configuration having 24 RBs of frequency resources for downlink notification.

Some embodiments may operate as follows. The UE enters into the network using legacy system information (SI)/SSB operations, e.g. a legacy initial access procedure. During the initial access, the UE reports its UE capability, and there is a pre-defined/configured association between UE type/capability/service and one or more PDCCH resource configurations for downlink notifications (e.g. for paging). The UE may be involved in active data transmissions as normal. However, before the UE transitions to a power saving mode (e.g. Inactive or Idle state), the network can configure the UE with the appropriate PDCCH resources for downlink notification monitoring based on, for example, the UE type and/or capability and/or service and/or time of 24-hour day. For example, a power sensitive UE may be configured with PDCCH resources having a reduced bandwidth (e.g. 6 RBs) for downlink notification. The PDCCH resource configuration may be included in an RRC release configuration message. The UE may wake up to monitor for downlink notifications using the configured customized PDCCH.

In some embodiments, when a UE 110 transitions out of the power saving state, e.g. into active data transmission or reception, the UE 110 may keep the PDCCH resource configuration that was configured for the power saving state, unless/until the configuration is updated.

In some embodiments, one of different possible PDCCH resource configurations for downlink monitoring may instead (or also) be obtained by the UE 110 during initial access to network, e.g. based on the UE capabilities, type, and/or service type. There may be an association between UE type, capability, and/or type of service implemented by the UE and PDCCH resource configuration for downlink notification (e.g. paging). The association may be pre-defined and/or configured (e.g. RRC configured). In some embodiments, the PDCCH resource configuration for downlink monitoring may be for a power saving mode only, or for a default operating mode, or possibly also for active communication mode, with the different options being configurable (e.g. in higher layer signaling, such as RRC signaling, or in a MAC CE).

In one example, in some embodiments during initial access to network, system information (e.g. a SIB 1 or SIBx message(s)) may indicate a set of PDCCH resource configurations. Each PDCCH resource configuration may have a different bandwidth of frequency resources, and each PDCCH resource configuration may be associated with a different UE type, capability, and/or type of service that is predefined. For example, system information may indicate, for each of a plurality of UE types and/or capabilities and/or services: a BWP, a CORESET within the BWP, and/or search space within the CORESET for PDCCH monitoring for that UE type/capability/service. The information may be broadcast or group-cast in pre-defined frequency resources and/or time domain periods, for different UE types, capability, and/or types of service.

Depending upon its UE type, capability, and/or service, the UE selects the appropriate PDCCH resource configuration from those indicated in the system information. For example, a power sensitive UE might select a PDCCH resource configuration for downlink notification (e.g. paging) monitoring that is only 6 RBs, whereas a UE that is not power sensitive might select a PDCCH resource configuration that is 24 RBs. In some embodiments, the indication of the set of PDCCH resource configurations is broadcast in a SIB 1 or SIBx message. In some embodiments, the indication of the set of PDCCH resource configurations may be located at predefined time-frequency resources. In some embodiments, the indication of the set of PDCCH resource configurations is provided in response to a UE request during initial access. In some embodiments, one or more customized SIB messages are used to indicate the set of PDCCH resource configurations.

In some embodiments, the UE notifies the network of the selected PDCCH resource configuration(s) in one or more operating states (or modes). The notification may be explicit or implicit. An example of an implicit indication is the UE indicating its type, capability, and/or service to the network, which the network knows is associated with a particular PDCCH resource configuration, e.g. via a predefined mapping.

In some embodiments, the UE may keep using the selected PDCCH resource configuration(s) for active communication mode and/or power saving mode. In some embodiments, higher layer signaling (e.g. RRC signaling) or a MAC CE may be used to configure settings related to the PDCCH resource configuration, such as whether the UE keeps using the selected PDCCH resource configuration for certain modes of operation or operating states.

In some embodiments, during the initial access procedure the UE receives a categorized set of paging PDCCH resource configurations from one or more SIB messages, where:
(A) If there is a one-to-multiple mapping between UE device type/capability/service and possible PDCCH resource configurations, the UE may select one of the multiple PDCCH resource configurations for monitoring for downlink notifications for several or all operating states, and then notify the TRP 352 of the selected PDCCH resource configuration(s) so that the network can implement the corresponding correct downlink notification control channel for that UE.
(B) If there is a one-to-multiple mapping between UE device type/capability/service and possible PDCCH resource configurations, the UE may select one of the multiple PDCCH resource configurations for monitoring for downlink notifications for one operating state, and the UE may select another one of the multiple PDCCH resource configurations for monitoring for downlink notification for another operating state. The UE may notify the TRP 352 of the selected PDCCH resource configuration(s) so that the network can implement the corresponding correct downlink notification control channel for that UE. In some instances, the UE may notify the TRP 352 of the selected PDCCH resource configuration(s) for each of its operating states. In other instances, the UE may notify the TRP 352 of only the PDCCH resource configuration(s) corresponding to the current operating state, and when the UE transitions to a different operating state the UE notifies the TRP 352 of the selected PDCCH resource configuration(s) for the new operating state as needed.
(C) If there is unique (one-to-one) mapping between UE device type/capability/service and PDCCH resource configuration, the UE may select and implement the PDCCH resource configuration corresponding to its type/capability/service, and there might not be a need to notify the TRP 352 of the selected PDCCH resource configuration, e.g. if the network knows the UE type/capability/service from another message (e.g. from a capability report) such that the network knows which PDCCH resource configuration has been selected and is to be implemented for that UE.

In any of scenarios (A) to (C) above, it is possible that the network may indicate (via a message sent from TRP 352) a new PDCCH resource configuration to the UE in any operating state or before or at a state transition.

In some embodiments, if the network provides more than one possible PDCCH resource configuration for a given UE type, capability, and/or type of service, the UE may select from the different possible configurations for its given UE type, capability, and/or service based on other conditions, e.g. traffic type, and/or application requirement, etc. The UE notifies the network of the selected configuration(s).

In another example, during the initial access procedure a UE 110 notifies the network of its type, capability, and/or service (e.g. in a capability report), and in response the network transmits (via TRP 352), to UE 110, an indication of a PDCCH resource configuration to be used by that UE 110 for downlink notification monitoring. The network selects one of two or more possible different PDCCH resource configurations based on the UE type, capability, and/or service. The transmission of the PDCCH resource configuration may be during the initial access procedure, e.g. in system information, such as in a SIB. In such embodiments, a set of PDCCH resource configurations might not be sent from the network, just the single PDCCH resource configuration selected by the network at that point for the UE. In other embodiments, based on UE type, capability, and/or service (e.g. in a capability report), the network transmits (via TRP 352), to UE 110, an indication of PDCCH resource configurations to be used by that UE 110 for downlink notification monitoring in different operating modes (or states), respectively.

In some embodiments, different SSBs may be transmitted from the network, with each SSB associated with transmission of respective different system information (e.g. SIB) indicating for UEs with different UE type, capability, and/or service a respective different PDCCH resource configuration for downlink notification monitoring. For example, a first SSB may include a MIB that indicates the time-frequency location of resources in a PDCCH at which scheduling information for a SIB is located. The SIB indicates a PDCCH resource configuration having 6 RBs for monitoring for downlink notifications. A second SSB may include a MIB that indicates the time-frequency location of resources in a PDCCH at which scheduling information for a different SIB is located. That SIB indicates a PDCCH resource configuration having 24 RBs for monitoring for downlink notifications. In operation, in one example, a UE of one type/capability (e.g. a power sensitive UE) performs initial access using the first SSB to obtain the PDCCH resource configuration of 6 RBs for monitoring for downlink notifications. A UE of another type/capability (e.g. a UE that is not power sensitive) performs initial access using the second SSB to obtain the PDCCH resource configuration of 24 RBs for monitoring for downlink notifications. The UE needs to select an appropriate SSB depending upon it type/capability and/or desired PDCCH resource configuration. In some embodiments, the pilot sequence, reference signal, and/or synchronization signal (e.g. SSS and/or PSS) has a known association with a particular PDCCH resource configuration or UE type or capability, such that the UE knows whether to proceed with initial access on a particular SSB based on the pilot sequence, reference signal, and/or synchronization signal of that SSB. For example, a power sensitive UE might begin to synchronize and perform initial access on the second SSB, but realize from the identity of the pilot sequence, reference signal, and/or synchronization signal of that SSB that the resulting PDCCH resource configuration will not be suitable. The UE may abandon and try another SSB (e.g. the first SSB) and continue with the initial access upon realizing that the identity of the pilot sequence, reference signal, and/or synchronization signal of that SSB will result in a suitable PDCCH resource configuration. As discussed later, in some embodiments the frequency resources used for initial access may be different for different SSBs. In such embodiments, SSBs associated with fewer frequency resources may also be associated with system information that indicates a PDCCH resource configuration for downlink monitoring that is also fewer frequency resources.

In all of the embodiments in which the UE obtains, during an initial access procedure, a PDCCH resource configuration for downlink notification monitoring, the configuration might be for only when the UE is operating in a power saving state. In such embodiments, depending upon the implementation and/or UE, the UE might operate in a power saving state all of the time, most of the time, or some of the time. In embodiments in which the UE is Active/Connected upon completion of the initial access, the PDCCH resource configuration for downlink notification monitoring, which was obtained during initial access, might only be used when the UE transitions to a power saving state. In other embodiments, the PDCCH resource configuration might also be used in an Active/Connected state. In some embodiments, when in the Active/Connected state, the network might reconfigure the PDCCH resource configuration for downlink notification monitoring.

In some embodiments, if a PDCCH resource configuration for downlink notification monitoring is obtained during initial access, then the PDCCH resource configuration is not indicated as part of the signaling protocol/exchange when transitioning the UE to a power saving state. This is because the UE already has a PDCCH resource configuration for downlink notification monitoring in the power saving state. In other embodiments, the PDCCH resource configuration may be indicated as part of the signaling protocol/exchange when a UE is transitioning to a power saving state, regardless of whether a PDCCH resource configuration was obtained during initial access.

In some embodiments, a UE (e.g. a power sensitive UE) that is to obtain a PDCCH resource configuration during initial access may receive a SIB 1 message but further request one or more SIB messages for a customized PDCCH resource configuration for its UE type, capability, and/or service. In response, the network may transmit one or more SIB messages carrying the PDCCH resource configuration (e.g. indicating a BWP, CORESET, and/or search space).

In some embodiments, the MIB or system information may indicate the number of associations between UE types, capabilities, and/or services and PDCCH resource configurations. One or more SIB messages (e.g. SIB 1 and/or SIBx) may then indicate the PDCCH resource configuration (e.g. the BWP, CORESET, and/or search space). The PDCCH resource configuration may be indicated at predefined time and frequency resources. Each PDCCH resource configuration may correspond to/be associated with a respective UE type, capability, service, and/or time-of-24-hour day.

In some embodiments, regardless of when the UE obtains the PDCCH resource configuration for downlink notification monitoring, that PDCCH resource configuration (and/or the association between UE and PDCCH resource configuration) might need to be saved for the UE or UE type, capability, and/or service by the radio access network (RAN) 120, e.g. so that RAN paging sends a paging notification that is appropriate (e.g. the appropriate number of bits) for the PDCCH resource configuration. RAN nodes (e.g. TRPs) may need to exchange this information with each other, e.g. on a backhaul or TRP-to-TRP interface. In some embodiments, the core network (CN) may also or instead need to explicitly indicate the UE type, capability, and/or service (if not able identified by the UE ID) to each RAN for, e.g., paging, so that a notification is sent that is appropriate (e.g. appropriate number of bits) for the PDCCH resource configuration.

In some embodiments, a UE may be configured with multiple PDCCH resource configurations, and which PDCCH resource configuration to keep/use by the UE in a power saving state may pre-defined, RRC configured or dynamically indicated by the network.

### Power Saving During Initial Access Procedure

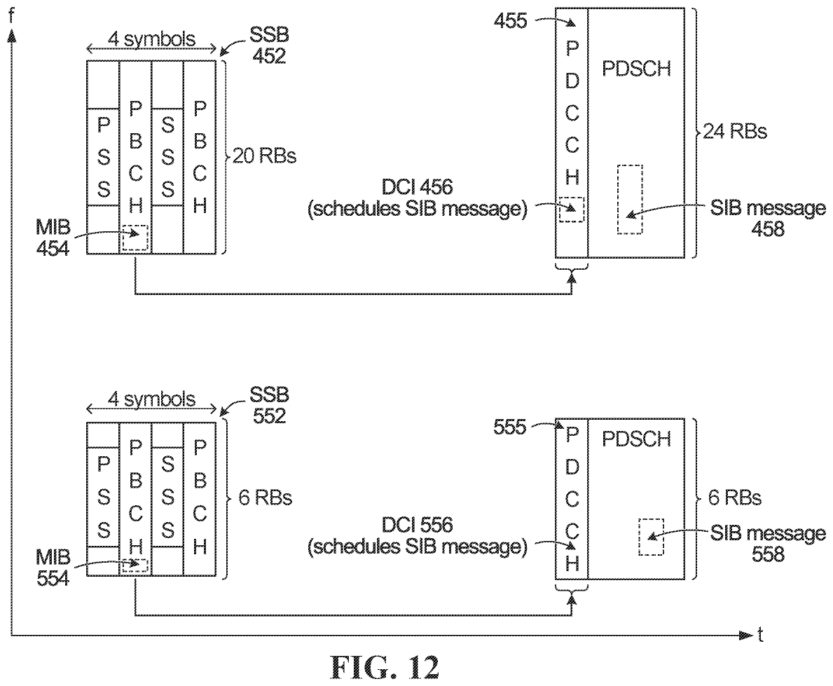

In addition to or instead of the embodiments above, the frequency resources used by a UE during an initial access procedure may be reduced, which may provide power savings. Different SSBs and/or PDCCHs used for UE synchronization and initial access may have different bandwidths and may be associated with different UE capabilities, types, and/or services. As an example, FIG. 12 illustrates different SSBs transmitted by a network according to one embodiment. The different SSBs may be transmitted by a same TRP or by different TRPs. The different SSBs might be transmitted in a same coverage area.

SSB 452 is the same as that illustrated in FIG. 8. It includes four symbols having a frequency resource of 20 RBs. The SSB 452 carries a MIB 454 that indicates the time-frequency location of resources in a PDCCH 455 at which control information is transmitted relating to the initial access. The PDCCH 455 indicated in the MIB 454 is 24 RBs. A UE performing initial access using SSB 452 obtains the MIB 454 and monitors the PDCCH 455 of 24 RBs to obtain DCI 456, which schedules transmission of a SIB message 458.

In some embodiments, another SSB 552 is also transmitted that only has a frequency resource of 6 RBs (or any other small or suitable number of RBs), which may be specifically applicable to some type of power sensitive UEs (who are different from the legacy UEs listening to SSB 452), for example The SSB 552 carries a MIB 554 that that indicates the time-frequency location of resources in another PDCCH 555 at which control information is transmitted relating to the initial access to network. The PDCCH 555 indicated in the MIB 554 is also only 6 RBs. A UE performing system synchronization and initial access using SSB 552 obtains the MIB 554 and monitors the PDCCH 555 of 6 RBs to obtain DCI 556, which schedules transmission of a SIB message 558.

Each SSB may be associated with a different UE type, capability, and/or service. The association may be predefined (e.g. in a standard) or configured. The UE performs initial access using the SSB corresponding to its type, capability, and/or service. For example, SSB 452 may be associated with UEs for which power sensitivity is not a concern and/or for which throughput is important. SSB 552 may be associated with UEs for which power sensitivity is a concern. For example, UE 110z introduced earlier may use SSB 452 for initial access because UE 110z is not as power sensitive, whereas UE 110x may use SSB 552.

By performing initial access using fewer frequency resources, e.g. using SSB 552 and its associated PDCCH, rather than SSB 452 and its associated PDCCH, power savings may be possible because fewer resources need to be monitored, detected, and/or decoded.

In some embodiments, SSB 452 may be associated with legacy UEs for backwards compatibility with previous standards, and SSB 552 may be associated with other UEs (perhaps all other UEs).

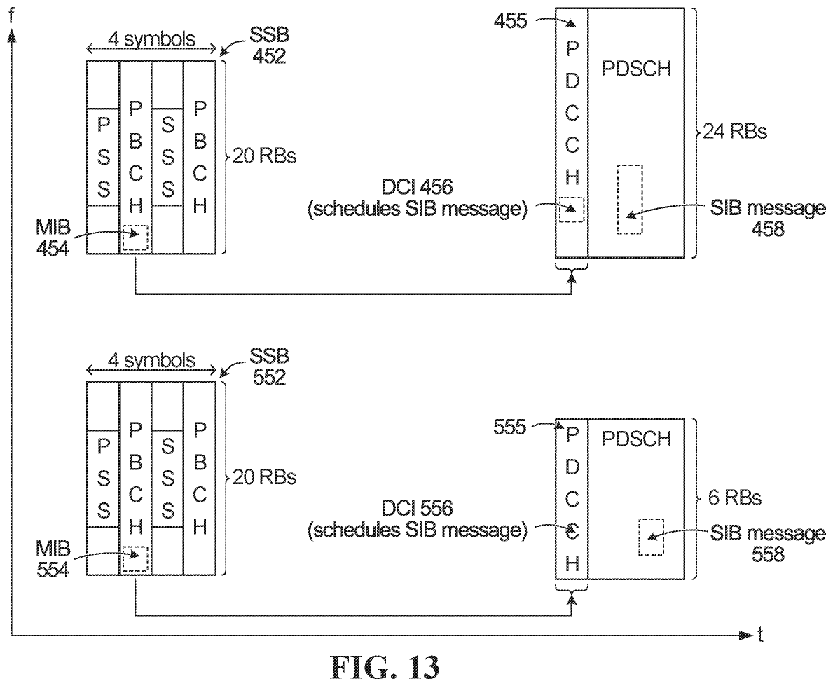

FIG. 12 is only an example, and multiple variations are possible. For example, although there are only two examples of different SSB/PDCCH configurations shown in FIG. 12, there may be more than two configurations. Also, the 20 RBS, 24 RBs, and 6 RBs bandwidths are only examples. Also, the PDSCH in each example in FIG. 12 does not have to be the same bandwidth as the PDCCH scheduling a SIB message on that PDSCH. It could be that a PDSCH has a different bandwidth and/or is on a different BWP from the PDCCH scheduling that PDSCH. In another variation, two or more SSBs may have the same bandwidth, but their PDCCH may be of different bandwidths. For example, FIG. 13 illustrates a variation of FIG. 12 in which the SSB 452 and 552 have the same bandwidth for synchronization and obtaining MIB, but for SSB 552, the MIB 554 indicates a PDCCH 555 that is only 6 RBs. A power sensitive UE may perform initial access using SSB 552 to obtain possible power savings relating to monitoring the PDCCH to obtain system information.

In any case, in FIGS. 12 and 13, the SIB message 458 and 558 may be used to indicate a PDCCH resource configuration for monitoring for downlink notifications. In some embodiments, an initial access procedure that uses fewer frequency resources may be associated with system information (e.g. a SIB message) that indicates a PDCCH resource configuration for monitoring for downlink notifications that is also fewer resources. For example, SIB message 458 indicates a PDCCH resource configuration for downlink notification monitoring that is 24 RBs (like what is configured for UE 110z in FIG. 11), whereas SIB message 558 indicates a PDCCH resource configuration for downlink notification monitoring that is 6 RBs (like what is configured for UE 110x in FIG. 11). In some embodiments, SIB message 458 and/or 558 may indicate multiple possible PDCCH resource configurations for a given UE type, capability, and/or service, in which case the UE may select between the different ones and notify the network. It should be noted that the reduced frequency resources used for SSB 552, SIB PDCCH/PDSCH 555 and/or paging PDCCH/PDSCH (configured in SIB messages) are for UE power saving during system synchronization and initial access to network; however, the frequency resource bandwidths used in SSB 552, SIB PDCCH/PDCCH 555 and/or paging PDCCH/PDSCH might not be necessarily all the same (even if for one type or same category of UEs).

### Example Methods

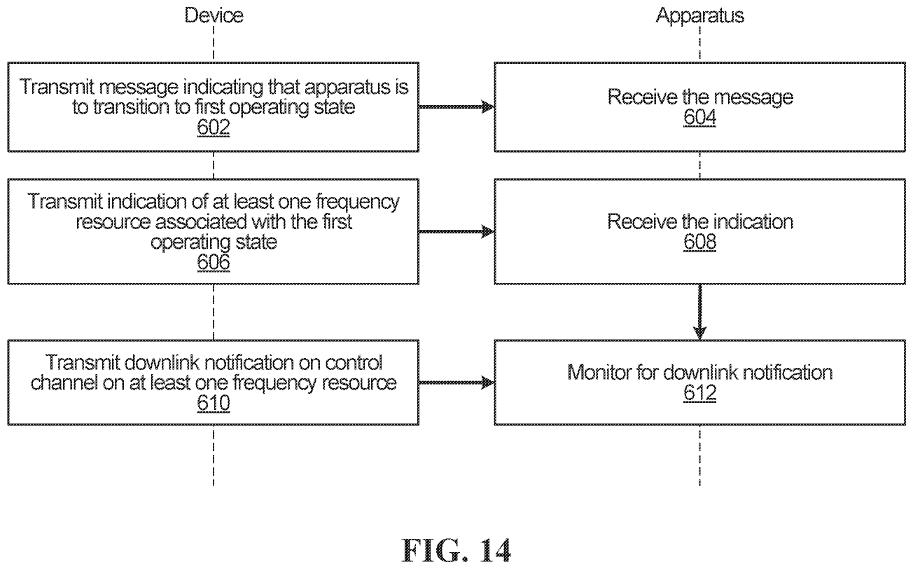

FIG. 14 illustrates a method performed by an apparatus and a device, according to one embodiment. The apparatus may be an ED 110, e.g. a UE, although not necessarily. The device may be a network device, e.g. a TRP 352, although not necessarily.

At step 602, the device transmits a message indicating that the apparatus is to transition to a first operating state of at least one operating state. In one example, the first operating state is a power saving state. For example, there may be a plurality of states including a non-power-saving state (e.g. Active/Connected) and a power saving stage (e.g. Inactive or Idle). In some embodiments, the message may be a release message, such as a SuspendConfig or RRC release message discussed earlier. At step 604, the apparatus receives the message.

At step 606, the device transmits an indication of at least one frequency resource for a control channel (or possibly instead a data channel), where the at least one frequency resource is associated with the first operating state. The at least one frequency resource is what is to be monitored, by the apparatus, for a downlink notification when the apparatus is in the first operating state. An example of the at least one frequency resource is the 6 RBs monitored by UE 110x when UE 110x wakes up in FIG. 11 discussed earlier. At step 608, the apparatus receives the indication of the at least one frequency resource. In some embodiments, the indication of the at least one frequency resource is transmitted by the device along with or by transmitting an indication of at least one of: a bandwidth (e.g. a BWP); a CORESET (e.g. within the bandwidth); or a search space (e.g. within the CORESET). For example, by indicating the BWP, CORESET, and search space the frequency resource(s) over which the monitoring is to occur is indicated. In such embodiments, the indication of the at least one frequency resource is received by the apparatus along with or by receiving the indication of at least one of the bandwidth (e.g. a BWP), CORESET, or search space.

In some embodiments, steps 606 and 608 may happen before or in parallel to steps 602 and 604.

At step 610, the device communicates with the apparatus in the first operating state by at least transmitting a downlink notification on the control channel at the at least one frequency resource. At step 612, the apparatus monitors for the downlink notification, in the first operating state, on the control channel at the at least one frequency resource. In some embodiments, the monitoring is implemented by performing blind detection on the search spaces (PDCCH candidates) on the at least one frequency resource. For example, at each configured time occasion, the apparatus performs blind detection on the control channel at the at least one frequency resource to determine whether the downlink notification is present. Blind detection is described earlier.

By performing the method of FIG. 14, the apparatus may be provided with a frequency resource configuration for downlink monitoring when the apparatus is in the first operating state (e.g. in the power saving state). The frequency resource configuration may be in the form of a PDCCH resource configuration described earlier. The configuration may be provided when the apparatus is being transitioned into the first operating state, although the configuration could be provided earlier. Different apparatuses may be provided with different configurations, e.g. customized to the apparatus type, apparatus capability, service type, and/or time of 24-hour day. For example, in some embodiments in FIG. 14, the at least one frequency resource is associated with at least one of: apparatus type, apparatus capability, service type, or time of 24-hour day. Different configurations of frequency resources for downlink monitoring may be associated with different type, capability, and/or service scenarios. In one example, an apparatus that is power sensitive may be associated with/provided with a configuration having fewer frequency resources for downlink monitoring, thereby possibly providing for power savings, as described earlier. Hence, in some embodiments of FIG. 14, a bandwidth of the at least one frequency resource is different from a bandwidth of at least one other frequency resource in a control channel used by another apparatus in the first operating state to monitor for a different downlink notification. An example is FIG. 11 in which UE 110z in a power saving state monitors for a downlink notification over a bandwidth of 24 RBs and UE 110x in a power saving state monitors for a downlink notification over a bandwidth of 6 RBs. Any of the variations described earlier, including in relation to FIG. 11, may be applied to the embodiment of FIG. 14.

In some embodiments of the method of FIG. 14, the downlink notification is an indication included in a DCI that schedules a notification message (e.g. downlink message) to be transmitted by the device and received by the apparatus. This is the case in the example in FIG. 11 in which the downlink notification schedules a downlink message in a PDSCH. However, in other embodiments, the downlink notification may be a notification message included in a DCI (e.g. a short message), in which case there might not be any message scheduled by the DCI. In any case, in some embodiments, the downlink notification may relate to paging, e.g. it is a paging notification.

In some embodiments of the method of FIG. 14, the message indicating that the apparatus is to transition to the first operating state is transmitted by the device (and received by the apparatus) subsequent to transmission of the indication of the at least one frequency resource. For example, the indication of the at least one frequency resource may be transmitted by the device (and received by the apparatus) when the apparatus is in an active state (e.g. when the apparatus is in an RRC Active/Connected state). Then, at a later point, the apparatus is indicated (via the message) to transition to the first operating state, e.g. to transmission to an inactive or idle state, such as an RRC Inactive or RRC Idle state. In some embodiments, the message specifically indicates that the apparatus is to transition from the active state to an inactive or idle state.

In some embodiments of the method of FIG. 14, a bandwidth of the at least one frequency resource is different from a bandwidth of at least one other frequency resource in a control channel used by another apparatus (or the same apparatus) in a second operating state to monitor for a different downlink notification. For example, the first operating state may be a power saving state having a bandwidth for monitoring of 6 RBs, and the second operating state may be a non-power saving state having a bandwidth for monitoring of 24 RBs.

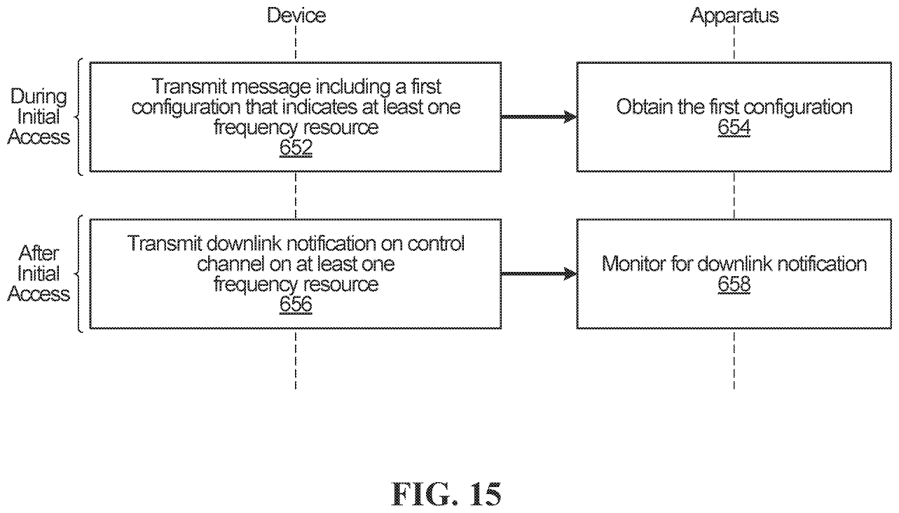

FIG. 15 illustrates a method performed by an apparatus and a device, according to another embodiment. The apparatus may be an ED 110, e.g. a UE, although not necessarily. The device may be a network device, e.g. a TRP 352, although not necessarily.

At step 652, during an initial access procedure the device transmits, to an apparatus, a message including a first configuration of a plurality of configurations. The first configuration indicates at least one frequency resource for at least one control channel (or data channel), which is to be used by the apparatus to monitor for a downlink notification. In some embodiments, the first configuration is based on at least one of: the apparatus capability, the apparatus type, or service type. For example, different ones of the plurality of configurations indicate different bandwidths of frequency resources for downlink monitoring, and the different ones of the plurality of configurations are associated with different apparatus capability, type, or service. For example, an apparatus that is power sensitive may obtain a configuration having fewer frequency resources (e.g. 6 RBs) for downlink notification monitoring, and an apparatus that is not power sensitive may obtain another one of the configurations having more frequency resources (e.g. 24 RBs) for downlink notification monitoring.

At step 654, the apparatus obtains the first configuration. As per the different variations described earlier, in some embodiments, the message transmitted at step 652 may indicate only the first configuration, which the apparatus obtains. For example, the first configuration may be selected by the device based on the type or capability of the apparatus and indicated to the apparatus in the message transmitted at step 652. In other embodiments, the message transmitted in step 652 may indicate several different ones (or all) of the plurality of configurations, and the apparatus might obtain the first configuration by selecting it, e.g. based on the apparatus capability/type/service.

At step 656, the device communicates with the apparatus after the initial access procedure, including transmitting a downlink notification on the at least one control channel at the least one frequency resource. At step 658, the apparatus monitors the at least one control channel at the at least one frequency resource for a downlink notification. In some embodiments, the monitoring is implemented by performing blind detection on the search spaces (PDCCH candidates) on the at least one frequency resource. For example, at each configured time occasion, the apparatus performs blind detection on the control channel at the at least one frequency resource to determine whether the downlink notification is present. Blind detection is described earlier.

By performing the method of FIG. 15, the apparatus may be provided with a frequency resource configuration for downlink monitoring during initial access that is specific to the apparatus capability, type, and/or service. Different apparatuses may obtain different configurations. For example, a power sensitive apparatus may obtain a frequency resource configuration for downlink notification monitoring of 6 RBs and a non-power-sensitive apparatus may obtain a frequency resource configuration for downlink notification monitoring of 24 RBs, like in the example explained earlier in relation to FIG. 11. Any of the variations described earlier, including in relation to FIG. 11, may be applied to the embodiment of FIG. 15.

In some embodiments of the method of FIG. 15, the at least one frequency resource may have a bandwidth that is different from a bandwidth of at least one other frequency resource for downlink notifications that is associated with a second configuration of the plurality of configurations. In this way, apparatuses of different capabilities, types, and/or services may possibly have different configurations of frequency resources of different bandwidths for monitoring for downlink notifications. For example, an apparatus that is power sensitive may be configured with a smaller bandwidth of frequency resources.

In some embodiments of the method of FIG. 15, the apparatus obtains the first configuration by selecting the first configuration from the plurality of configurations. The apparatus may optionally transmit a message notifying a network of the first configuration, e.g. if the network does not know which configuration the apparatus selected.

In some embodiments of the method of FIG. 15, the apparatus transmits a capability report to a network during the initial access procedure, and the first configuration may be received from the network subsequent to transmitting the capability report. For example, the device may obtain the capability (and/or type and/or service) from the capability report, select an appropriate associated configuration (the “first configuration” in FIG. 15), and indicate that to the apparatus in the message transmitted in step 652.

In some embodiments of the method of FIG. 15, the initial access procedure is performed using a SSB having a bandwidth that is associated with at least one of: the apparatus capability, the apparatus type, or service type. In some such embodiments, the apparatus may select the appropriate SSB corresponding to its capability, type, and/or service. Examples are discussed in relation to FIG. 12. Any of the variations described earlier, including in relation to FIG. 12, may be applied to the embodiment of FIG. 15.

In some embodiments of the method of FIG. 15, during the initial access procedure, the apparatus may access system information using at least one frequency resource of a control channel that has a bandwidth that is associated with at least one of: the apparatus capability, the apparatus type, or service type. Examples are discussed in relation to FIG. 13. Any of the variations described earlier, including in relation to FIG. 13, may be applied to the embodiment of FIG. 15.

In some embodiments of the method of FIG. 15, the downlink notification is an indication included in a DCI that schedules a notification message (e.g. downlink message) to be transmitted by the device and received by the apparatus. This is the case in the example in FIG. 11 in which the downlink notification schedules a downlink message in a PDSCH. However, in other embodiments, the downlink notification may be a notification message included in a DCI (e.g. a short message), in which case there might not be any message scheduled by the DCI. In any case, in some embodiments, the downlink notification relates to paging, e.g. it is a paging notification.

Examples of an apparatus (e.g. ED or UE) and a device (e.g. TRP) to perform the various methods described herein are also disclosed.

The apparatus may include a memory to store processor-executable instructions, and at least one processor to execute the processor-executable instructions. When the processor executes the processor-executable instructions, the processor may be caused to perform the method steps of the apparatus as described herein, e.g. in relation to FIGS. 14 and/or 15. As one example, the at least one processor may receive a message indicating that the apparatus is to transition to the first operating state in FIG. 14 (e.g. the power saving state). The processor may receive the message by receiving it at an input of the processor. In some embodiments, the message may be decoded by the processor to read the information in the message. The at least one processor may also receive an indication of at least one frequency resource for a control channel, where the at least one frequency resource is associated with the first operating state. The processor may receive the indication by receiving it at an input of the processor. In some embodiments, the indication may be decoded by the processor to read the information in the indication. The at least one processor may monitor for a downlink notification, in the first operating state, on the control channel at the at least one frequency resource. The monitoring may be implemented by the processor performing the blind detection described earlier. In another example, in relation to FIG. 15, the at least processor may, during an initial access procedure, obtain the first configuration of a plurality of configurations. How the processor obtains the first configuration is implementation specific. For example, the processor may receive it at the input of the processor, and/or decode a message received at the processor and read the information in the decoded message as the first configuration, and/or select the first configuration from a plurality of configurations (in which case it might be that the plurality of configurations are read from information obtained from decoding a message received at the input of the processor). The at least one processor may monitor the at least one control channel at the at least one frequency resource for a downlink notification. The monitoring may be implemented by the processor performing the blind detection described earlier.

The device may include a memory to store processor-executable instructions, and at least one processor to execute the processor-executable instructions. When the at least one processor executes the processor-executable instructions, the at least one processor may be caused perform the method steps of the device as described above, e.g. in relation to FIGS. 14 and/or 15. As an example, and in relation to FIG. 14, the at least one processor may output, for transmission, a message indicating that an apparatus is to transition to a first operating state of at least one operating state. The message may be generated by the at least processor, e.g. information encoded in the processor to produce the message, prior to outputting the message. The at least one processor may output, for transmission, an indication of at least one frequency resource for a control channel, where the at least one frequency resource is associated with the first operating state. The indication may be generated by the at least processor, e.g. information encoded in the processor to produce the indication, prior to outputting the indication. The at least one processor may output a downlink notification for transmission on the control channel at the at least one frequency resource. The downlink notification may have been generated by the at least one processor, e.g. by encoding a DCI carrying the downlink notification. As another example, and in relation to FIG. 15, the at least one processor may, during an initial access procedure, output for transmission to an apparatus, a message including a first configuration of a plurality of configurations, where the first configuration indicates at least one frequency resource for at least one control channel, and where the first configuration is based on at least one of the apparatus capability, the apparatus type, or service type. The at least one processor may select and/or indicate the first configuration, e.g. based on the apparatus capability, the apparatus type, or service type. The at least one processor may generate the message by encoding the information indicating the first configuration. After the initial access procedure, the at least one processor may output a downlink notification for transmission on the at least one control channel at the least one frequency resource. The downlink notification may have been generated by the at least one processor, e.g. by encoding a DCI carrying the downlink notification.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus, the method comprising:
receiving a message indicating that the apparatus is to transition to a first operating state of at least one operating state;
receiving an indication of at least one frequency resource for a control channel, wherein the at least one frequency resource is associated with the first operating state;
monitoring for a downlink notification, in the first operating state, on the control channel at the at least one frequency resource.

2. The method of claim 1, wherein the first operating state is a power saving state.

3. The method of claim 1, wherein the at least one frequency resource is associated with at least one of: apparatus type, apparatus capability, service type, or time of 24-hour day.

4. The method of claim 1, wherein a bandwidth of the at least one frequency resource is different from a bandwidth of at least one other frequency resource in a control channel used by another apparatus in the first operating state to monitor for a different downlink notification.

5. The method of claim 1, wherein monitoring for the downlink notification on the control channel at the at least one frequency resource comprises: at a configured time occasion, performing blind detection on the control channel at the at least one frequency resource to determine whether the downlink notification is present.

6. The method of claim 1, wherein the downlink notification is an indication included in a downlink control information (DCI) that schedules a notification message to receive, or is a notification message included in a DCI.

7. The method of claim 1, wherein the indication of the at least one frequency resource is received along with or by receiving an indication of at least one of: a bandwidth; a control resource set (CORESET) within the bandwidth; or a search space within the CORESET.

8. The method of claim 1, wherein the message indicating that the apparatus is to transition to the first operating state is received subsequent to receiving the indication of the at least one frequency resource.

9. The method of claim 1, wherein the indication of the at least one frequency resource is received when the apparatus is in an active state, and wherein the message indicates that the apparatus is to transition from the active state to an inactive or idle state.

10. The method of claim 1, wherein a bandwidth of the at least one frequency resource is different from a bandwidth of at least one other frequency resource in a control channel used by another apparatus in a second operating state to monitor for a different downlink notification.

11. An apparatus comprising:
at least one processor; and
a memory storing processor-executable instructions that, when executed, cause the at least one processor to:
receive a message indicating that the apparatus is to transition to a first operating state of at least one operating state;
receive an indication of at least one frequency resource for a control channel, wherein the at least one frequency resource is associated with the first operating state;
monitor for a downlink notification, in the first operating state, on the control channel at the at least one frequency resource.

12. A method performed by a device, the method comprising:
transmitting a message indicating that an apparatus is to transition to a first operating state of at least one operating state;
transmitting an indication of at least one frequency resource for a control channel, wherein the at least one frequency resource is associated with the first operating state;
communicating with the apparatus in the first operating state by at least transmitting a downlink notification on the control channel at the at least one frequency resource.

13. The method of claim 12, wherein the first operating state is a power saving state.

14. The method of claim 12, wherein the at least one frequency resource is associated with at least one of: apparatus type, apparatus capability, service type, or time of 24-hour day.

15. The method of claim 12, wherein a bandwidth of the at least one frequency resource is different from a bandwidth of at least one other frequency resource in a control channel used to transmit a different downlink notification to another apparatus in the first operating state.

16. The method of claim 12, wherein the downlink notification is an indication included in a downlink control information (DCI) that schedules a notification message, or is a notification message included in a DCI.

17. The method of claim 12, wherein the indication of the at least one frequency resource is transmitted along with or by transmitting an indication of at least one of: a bandwidth; a control resource set (CORESET) within the bandwidth; or a search space within the CORESET.

18. The method of claim 12, wherein the message indicating that the apparatus is to transition to the first operating state is transmitted subsequent to transmitting the indication of the at least one frequency resource.

19. The method of claim 12, wherein the indication of the at least one frequency resource is transmitted when the apparatus is in an active state, and wherein the message indicates that the apparatus is to transition from the active state to an inactive or idle state.

20. A device comprising:
at least one processor; and
a memory storing processor-executable instructions that, when executed, cause the at least one processor to:
output, for transmission, a message indicating that an apparatus is to transition to a first operating state of at least one operating state;
output, for transmission, an indication of at least one frequency resource for a control channel, wherein the at least one frequency resource is associated with the first operating state;
output a downlink notification for transmission on the control channel at the at least one frequency resource.
